(19) United States
(12) Patent Application Publication
(10) Pub. No.: US 2024/0266122 A1
(43) Pub. Date: Aug. 8, 2024

(54) FACILE FABRICATION OF MULTIVALENT VOx/GRAPHENE NANOCOMPOSITE ELECTRODES FOR ENERGY STORAGE DEVICES WITH HIGH ENERGY DENSITY

(71) Applicant: The Regents of the University of California, Oakland, CA (US)

(72) Inventors: Ailun Huang, Los Angeles, CA (US); Maher F. El-Kady, Los Angeles, CA (US); Richard B. Kaner, Pacific Palisades, CA (US); Yuzhang Li, Los Angeles, CA (US)

(21) Appl. No.: 18/561,089

(22) PCT Filed: May 27, 2022
(86) PCT No.: PCT/US2022/031351

§ 371 Date: Nov. 15, 2023

Related U.S. Application Data
(60) Provisional application No. 63/194,282, filed on May 28, 2021.

(51) Int. Cl. H01G 11/24; H01G 11/26; H01G 11/32; H01G 11/46; H01G 11/86; H01M 4/131; H01M 4/48; H01M 4/62

(52) U.S. Cl. CPC H01G 11/24; H01G 11/26; H01G 11/32; H01G 11/46; H01G 11/86; H01M 4/131; H01M 4/48; H01M 4/625

(57) ABSTRACT

Disclosed herein are vanadium active materials, methods of making the same, and energy storage devices comprising the same. The vanadium active material may be incorporated into an electrode with a graphene scaffold, the graphene scaffold having a three-dimensional network of interconnected pores, a first vanadium oxide in a first oxidation state, and a second vanadium oxide in a second oxidation state.

### CROSS REFERENCE

This application claims priority to U.S. provisional patent application 63/194,282 filed May 28, 2021, entitled FACILE FABRICATION OF MULTIVALENT VON/GRAPHENE NANOCOMPOSITE ELECTRODES FOR ENERGY STORAGE DEVICES WITH HIGH ENERGY DENSITY, the entirety of which is herein incorporated by reference.

### BACKGROUND

Vanadium energy storage devices may include vanadium flow batteries, a type of rechargeable flow battery that employs vanadium ions as charge carriers. However, the commercial applicability prior art of vanadium energy storage devices has been limited due relatively a poor energy-to-volume ratio and to low potential differences in systems utilizing vanadium active materials.

### SUMMARY

Disclosed herein are vanadium active materials that permit a much more widespread application and use of vanadium energy storage devices and methods of producing the same. The vanadium active materials and devices comprising such materials disclosed herein overcome a number of issues present with prior art vanadium energy storage devices, such as limited energy storage capacity, low charge and discharge rates, poor capacitance, and poor cycling stability, among other issues.

One such improved energy storage device that may be fabricated with the vanadium active materials disclosed herein may include supercapacitors. Supercapacitor devices have emerged as one of the leading energy-storage technologies due to their short charge/discharge time and exceptional cycling stability; however, the state-of-the-art energy density is relatively low. Hybrid electrodes based on transition metal oxides and carbon-based materials are considered as promising candidates to overcome this limitation. Disclosed are graphene/vanadium oxide (graphene/VOₓ) electrodes that incorporate vanadium oxides with multiple oxidation states onto highly conductive graphene scaffolds synthesized via a facile laser-scribing process. An exemplary graphene/VOₓ electrode exhibits a large potential window with a high three-electrode specific capacitance of about 1,110 F/g. The exemplary aqueous graphene/VOₓ symmetric supercapacitors (SSCs) have a high energy density of about 54 Wh/kg with little capacitance loss after 20,000 cycles. Moreover, the exemplary flexible quasi-solid-state graphene/VOₓ SSCs exhibit a very high energy density of about 72 Wh/kg, or about 7.7 mWhcm³, outperforming many commercial devices. With a charge transfer resistance (R_{ct})<0.02Ω and Coulombic efficiency close to 100%, these exemplary gel graphene/VOₓ SSCs can retain about 92% of their capacitance after about 20,000 cycles. The process enables the direct fabrication of redox-active electrodes that can be integrated with essentially any substrate, including silicon wafers and flexible substrates, showing great promise for next-generation large-area flexible displays and wearable electronic devices.

Aspects disclosed herein provide an electrode comprising a graphene scaffold, the graphene scaffold comprising a three-dimensional network of interconnected pores, a first vanadium oxide in a first oxidation state, and a second vanadium oxide in a second oxidation state. Aspects disclosed herein also provide a vanadium active material providing a graphene scaffold, the graphene scaffold comprising a three-dimensional network of interconnected pores, a first vanadium oxide in a first oxidation state, and a second vanadium oxide in a second oxidation state. In some embodiments, the graphene scaffold comprises an interconnected corrugated carbon-based network (ICCN) having a plurality of expanded and interconnected carbon layers. In some embodiments, the graphene scaffold comprises a pore size from about 0.1 μm to about 10 μm. In some embodiments, the graphene scaffold comprises a pore size from about 0.5 μm to about 5 μm. In some embodiments, there is a third vanadium oxide in a third oxidation state. In some embodiments, there is a fourth vanadium oxide in a fourth oxidation state. In some embodiments, the first vanadium oxide comprises Vanadium (III) Oxide (V₂O₃). In some embodiments, the concentration of V₂O₃ in the electrode is from about 60%-80% w/w. In some embodiments, the concentration of V₂O₃ in the electrode is about 70% w/w. In some embodiments, the V₂O₃ comprises a rhombohedral corundum-type structure. In some embodiments, the second vanadium oxide comprises Vanadium (IV) Oxide (VO₂). In some embodiments, the concentration of VO₂ in the electrode is from about 5%-25% w/w. In some embodiments, the concentration of VO₂ in the electrode is about 14.3% w/w. In some embodiments, there is a third vanadium oxide. In some embodiments, the third vanadium oxide comprises Vanadium (II) Oxide (VO). In some embodiments, the concentration of VO in the electrode is from about 5%-25% w/w. In some embodiments, the concentration of VO in the electrode is about 12.6% w/w. In some embodiments, there is a fourth vanadium oxide. In some embodiments, the fourth vanadium oxide comprises Vanadium (V) Oxide (V₂O₅). In some embodiments, the concentration of V₂O₅ in the electrode is from about 0.5%-15% w/w. In some embodiments, the concentration of V₂O₅ in the electrode is about 3.2% w/w. In some embodiments, the electrode comprises sharp peaks at about 24.4°, 33.2°, 36.4°, and 54.2° when analyzed by x-ray powder diffraction. In some embodiments, the electrode comprises a peak at about 514.9 eV when analyzed by x-ray photoelectron spectroscopy. In some embodiments, the electrode comprises a peak at about 512.9 eV when analyzed by x-ray photoelectron spectroscopy. In some embodiments, the electrode comprises a peak at about 517.9 eV when analyzed by x-ray photoelectron spectroscopy. In some embodiments, the electrode further comprises non-stoichiometric vanadium oxides. In some embodiments, the total vanadium oxide content is about 93% w/w, and the graphene content is about 6.8% w/w. In some embodiments, any of the vanadium oxides comprise vanadium oxide nanoparticles. In some embodiments, the vanadium oxide nanoparticles comprise a mean particle size ranging from about 10 nm to about 70 nm. In some embodiments, the vanadium oxide nanoparticles comprise a mean particle size ranging from about 15 nm to about 50 nm. In some embodiments, the vanadium oxide nanoparticles comprise a mean particle size ranging from about 15 nm to about 30 nm. In some embodiments, the vanadium oxide nanoparticles comprise a mean particle size ranging from about 20 nm to about 30 nm. In some embodiments, the vanadium oxide nanoparticles comprise a mean particle size ranging from about 25 nm to about 30 nm. In some embodiments, the vanadium oxide nanoparticles comprise a mean particle size of about 25 nanometers. In some embodiments, there is an interconnected network of vanadium oxide nanoparticles of differing particle size.

In some embodiments, the graphene scaffold comprises an oxygen-containing functional group comprising C—O, C—O—C, C═O, or COOH. In some embodiments, the vanadium oxide nanoparticles are anchored to the graphene scaffold. In some embodiments, the vanadium oxide nanoparticles are anchored to the graphene scaffold at the oxygen-containing functional group. In some embodiments, the vanadium oxide nanoparticles configured to improve the migration of an electrolyte ion into an active site of the electrode. In some embodiments, the electrode comprises a specific capacitance ranging from about 200 F/g at a scan rate of about 1,000 mV/s to about 1,050 F/g at a scan rate of about 10 mV/s. In some embodiments, the electrode comprises a peak specific capacitance of about 1,110 F/g at a scan rate of about 20 mV/s. In some embodiments, the electrode comprises a resistance from about 0.2 ohms to about 0.4 ohms. In some embodiments, the electrode comprises a resistance of about 0.28 ohms. In some embodiments, the mean areal loading of the vanadium oxides is from about 0.05 mg/cm² to about 0.75 mg/cm². In some embodiments, the mean areal loading of the vanadium oxides is about 0.3 mg/cm². In some embodiments, the electrode is about 5 μm to about 25 μm in thickness. In some embodiments, the electrode is about 15 μm thick. In some embodiments, the electrode is a nanocomposite electrode.

Aspects disclosed herein provide an energy storage device comprising: an electrode comprising a graphene scaffold, the graphene scaffold comprising a three-dimensional network of interconnected pores, a first vanadium oxide in a first oxidation state, and a second vanadium oxide in a second oxidation state; and an electrolyte. In some embodiments, there is a separator. In some embodiments, the graphene scaffold comprises an ICCN having a plurality of expanded and interconnected carbon layers. In some embodiments, the energy storage device is a SSC. In some embodiments, the energy storage device is a SSC comprising two electrodes of identical composition. In some embodiments, the SSC comprises about a 1.3 V operating voltage. In some embodiments, the SSC retains 100% of its initial capacitance after 10,000 cycles, or 20,000 cycles. In some embodiments, the SSC exhibits a triangular galvanostatic charge-discharge curve, or a galvanostatic charge-discharge curve comprising a first linear portion, a peak, and a second linear portion. In some embodiments, the galvanostatic charge-discharge curve maintains its shape at current densities of about 0.5, 1, 2 3, 4, and 5 A/g. In some embodiments, the SSC exhibits a resistance below about 5 ohms. In some embodiments, the SSC exhibits a cell voltage of at least about 1.3 V. In some embodiments, the SSC exhibits a cell voltage of about 1.3 V, 1.5 V, or 1.7 V. In some embodiments, the graphene scaffold has a pore size from about 0.1 μm to about 10 μm. In some embodiments, the graphene scaffold has a pore size from about 0.5 μm to about 5 μm. In some embodiments, there is a third vanadium oxide in a third oxidation state. In some embodiments, there is a fourth vanadium oxide in a fourth oxidation state. In some embodiments, the first vanadium oxide comprises Vanadium (III) Oxide (V₂O₃). In some embodiments, the concentration of V₂O₃ in the electrode is from about 60%-80% w/w. In some embodiments, the concentration of V₂O₃ in the electrode is about 70% w/w. In some embodiments, the V₂O₃ comprises a rhombohedral corundum-type structure. In some embodiments, the second vanadium oxide comprises Vanadium (IV) Oxide (VO₂). In some embodiments, the concentration of VO₂ in the electrode is from about 5%-25% w/w. In some embodiments, the concentration of VO₂ in the electrode is about 14% w/w. In some embodiments, there is a third vanadium oxide. In some embodiments, the third vanadium oxide comprises Vanadium (II) Oxide (VO). In some embodiments, the concentration of VO in the electrode is from about 5%-25% w/w. In some embodiments, the concentration of VO in the electrode is about 12.6% w/w. In some embodiments, there is a fourth vanadium oxide. In some embodiments, the fourth vanadium oxide comprises Vanadium (V) Oxide (V₂O₅). In some embodiments, the concentration of V₂O₅ in the electrode is from about 0.5%-15% w/w. In some embodiments, the concentration of V₂O₅ in the electrode is about 3.2% w/w. In some embodiments, the electrode comprises sharp peaks at about 24.4°, 33.2°, 36.4°, and 54.2° when analyzed by x-ray powder diffraction. In some embodiments, the electrode comprises a peak at about 514.9 eV when analyzed by x-ray photoelectron spectroscopy. In some embodiments, the electrode comprises a peak at 512.9 eV when analyzed by x-ray photoelectron spectroscopy. In some embodiments, the electrode comprises a peak at about 517.9 eV when analyzed by x-ray photoelectron spectroscopy. In some embodiments, there are non-stoichiometric vanadium oxides. In some embodiments, the total vanadium oxide content is about 93% w/w and the graphene content is about 6.8% w/w. In some embodiments, any of the vanadium oxides comprise vanadium oxide nanoparticles. In some embodiments, the vanadium oxide nanoparticles have a mean particle size ranging from about 10 nm to about 70 nm. In some embodiments, the vanadium oxide nanoparticles have a mean particle size ranging from about 15 nm to about 50 nm. In some embodiments, the vanadium oxide nanoparticles have a mean particle size ranging from about 15 nm to about 30 nm. In some embodiments, the vanadium oxide nanoparticles have a mean particle size ranging from about 20 nm to about 30 nm. In some embodiments, the vanadium oxide nanoparticles have a mean particle size ranging from about 25 nm to about 30 nm. In some embodiments, the vanadium oxide nanoparticles have a mean particle size of about 25 nanometers. In some embodiments, there is an interconnected network of vanadium oxide nanoparticles of differing particle size. In some embodiments, the graphene scaffold comprises an oxygen-containing functional group comprising C—O, C—O—C, C═O, or COOH. In some embodiments, at least a portion of the vanadium oxide nanoparticles are anchored to the graphene scaffold. In some embodiments, at least a portion of the vanadium oxide nanoparticles are anchored to the graphene scaffold at the oxygen-containing functional group. In some embodiments, the vanadium oxide nanoparticles improve the migration of an electrolyte ion into an active site of the electrode.

In some embodiments, the electrolyte is an aqueous electrolyte, and the device is an aqueous SSC. In some embodiments, the aqueous SSC retains about 119% of its initial capacitance after continuously being charged and discharged at about 40 A/g (12 mA cm⁻²) for about 10,000 cycles. In some embodiments, the aqueous SSC increases in capacitance by about 23% in the first 700 cycles. In some embodiments, the aqueous SSC retains about 112% of its initial capacitance after continuously being charged and discharged at about 40 A/g (12 mA cm⁻²) for about 20,000 cycles. In some embodiments, the aqueous SSC increases its initial capacitance by at least 20% after about 700 cycles. In some embodiments, the aqueous SSC maintains about 92% of its initial capacitance after about 19,000 cycles. In some embodiments, the aqueous SSC maintains about 92% of its peak capacitance after about 19,000 cycles. In some embodiments, the aqueous SSC maintains at least about 85% of its initial capacitance after about 19,000 cycles. In some embodiments, the aqueous SSC has an energy density of about 54 Wh/kg. In some embodiments, the aqueous SSC has an energy density of at least 45 Wh/kg. In some embodiments, the aqueous SSC has a power density of about 21 kW/kg. In some embodiments, the aqueous SSC has a power density of at least 15 kW/kg. In some embodiments, the aqueous SSC has an operating voltage of about 1.3 V and a gravimetric capacitance of about 229 F/g.

In some embodiments, the electrolyte comprises a gel electrolyte, and the device is a semisolid state SSC. In some embodiments, the gel electrolyte comprises LiCl/PVA. In some embodiments, the semisolid state SSC has a gravimetric device capacitance of about 208 F/g at a scan rate of has 1 mV/s. In some embodiments, the semisolid state SSC has an energy density of about 65 Wh/kg at a scan rate of about 1 mV/s. In some embodiments, the semisolid state SSC has a power density of about 156 W/kg at a scan rate of about 1 mV/s. In some embodiments, the semisolid state SSC is configured to increase the speed of faradic surface reactions. In some embodiments, the semisolid state SSC exhibits between about 80% and about 100% columbic efficiency. In some embodiments, the semisolid state SSC exhibits about 85% columbic efficiency at about 1 mV/s. In some embodiments, the semisolid state SSC exhibits at least about 85% columbic efficiency at scan rates from about 1 mV/s to about 1,000 mV/s. In some embodiments, the semisolid state SSC exhibits at least about 80% capacitance retention after about 10,000 cycles, or about 20,000 cycles. In some embodiments, the semisolid state SSC exhibits between about 90% to about 100% capacitance retention after about 10,000 cycles, or about 20,000 cycles. In some embodiments, the semisolid state SSC exhibits between about 90% to 100% capacitance retention after about 10,000 cycles, or about 20,000 cycles being continuously charged and discharged at about 30 A/g (9 mA cm⁻²). In some embodiments, the semisolid state SSC is a flexible semisolid state SSC. In some embodiments, the flexible semisolid state SSC maintains its cyclic voltammetry curves when bent. In some embodiments, the flexible semisolid state SSC maintains its columbic efficiency, energy density, power density, or capacitance when bent. In some embodiments, the flexible semisolid state SSC has an operating voltage of about 1.5 V, and a gravimetric capacitance of about 230 F/g. In some embodiments, the flexible semisolid state SSC has an operating voltage of about 1.7 V, and a gravimetric capacitance of about 150 F/g. In some embodiments, the flexible semisolid state SSC comprises a Coulombic efficiency ranging from about 85% to about 100%, wherein about 85% Coulombic efficiency is achieved at 1 mV/s, and wherein about 100% Coulombic efficiency is achieved at about 1000 mV/s to about 5 mV/s. In some embodiments, the flexible semisolid state SSC comprises a Coulombic efficiency ranging from about 85% to about 100%. In some embodiments, the supercapacitor device may increase in initial capacitance to a peak capacitance from about 1% to about 23% relative to an initial capacitance of the device. In some embodiments, the supercapacitor device may increase in initial capacitance to a peak of 1%, 2%, 3%, 4%, 5%, 6%, 7%, 8%, 9%, 10%, 11%, 12%, 13%, 14%, 15%, 16%, 17%, 18%, 19%, 20%, 21%, 22%, or 23% greater than the initial capacitance.

Aspects disclosed herein provide a method of producing an electrode comprising: providing a first solution of graphene oxide dissolved in an aqueous solution; providing a second solution of VCl₃ dissolved in an aqueous solution; mixing the first and second solutions to form a third solution; applying the third solution onto a substrate; drying the substrate; laser scribing the substrate to form the electrode. In some embodiments, the substrate is graphite paper, a polymer, a silicon wafer, a flexible substrate, or combinations thereof. In some embodiments, the first solution or the second solution is sonicated prior to mixing. In some embodiments, the first solution or the second solution is sonicated prior to mixing for a period of at least one hour. In some embodiments, the first solution or the second solution is sonicated prior to mixing for a period of about 2 hours. In some embodiments, the mixing comprises slowly adding the second solution to the first solution. In some embodiments, the mixing is controlled via a syringe pump. In some embodiments, the laser scribing comprises laser scribing with a 40 W full-spectrum CO₂ laser cutter at about 12% power. In some embodiments, the laser scribing the substrate reduces the graphene oxide and oxidizes the VCl₃ to a plurality of vanadium oxides. In some embodiments, the laser scribing the substrate reduces the graphene oxide and oxidizes the VCl₃ to a plurality of vanadium oxides simultaneously. In some embodiments, the graphene scaffold comprises a pore size from about 0.1 μm to about 10 μm. In some embodiments, the graphene scaffold has a pore size from about 0.5 μm to about 5 μm. In some embodiments, there is a third vanadium oxide in a third oxidation state. In some embodiments, there is a fourth vanadium oxide in a fourth oxidation state. In some embodiments, the first vanadium oxide comprises Vanadium (III) Oxide (V₂O₃). In some embodiments, the concentration of V₂O₃ in the electrode is from about 60%-80% w/w. In some embodiments, the concentration of V₂O₃ in the electrode is about 70% w/w. In some embodiments, the V₂O₃ comprises a rhombohedral corundum-type structure. In some embodiments, the second vanadium oxide comprises Vanadium (IV) Oxide (VO₂). In some embodiments, the concentration of VO₂ in the electrode is from about 5%-25% w/w. In some embodiments, the concentration of VO₂ in the electrode is about 14.3% w/w. In some embodiments, there is a third vanadium oxide. In some embodiments, the third vanadium oxide comprises Vanadium (II) Oxide (VO). In some embodiments, the concentration of VO in the electrode is from about 5%-25% w/w. In some embodiments, the concentration of VO in the electrode is about 12.6% w/w. In some embodiments, there is a fourth vanadium oxide in a fourth oxidation state. In some embodiments, the fourth vanadium oxide comprises Vanadium (V) Oxide (V₂O₅) in a fourth oxidation state. In some embodiments, the concentration of V₂O₅ in the electrode is from about 0.5%-15% w/w. In some embodiments, the concentration of V₂O₅ in the electrode is about 3.2% w/w. In some embodiments, the electrode comprises sharp peaks at about 24.4°, 33.2°, 36.4°, and 54.2° when analyzed by x-ray powder diffraction. In some embodiments, the electrode comprises a peak at 514.9 eV when analyzed by x-ray photoelectron spectroscopy. In some embodiments, the electrode comprises a peak at about 512.9 eV when analyzed by x-ray photoelectron spectroscopy. In some embodiments, the electrode comprises a peak at about 517.9 eV when analyzed by x-ray photoelectron spectroscopy. In some embodiments, there are non-stoichiometric vanadium oxides. In some embodiments, the total vanadium oxide content is about 93% w/w and the graphene content is about 6.8% w/w. In some embodiments, any one or more of the vanadium oxides comprise vanadium oxide nanoparticles. In some embodiments, the vanadium oxide nanoparticles have a mean particle size ranging from about 10 nm to about 70 nm. In some embodiments, the vanadium oxide nanoparticles have a mean particle size ranging from about 15 nm to about 50 nm. In some embodiments, the vanadium oxide nanoparticles have a mean particle size ranging from about 15 nm to about 30 nm. In some embodiments, the vanadium oxide nanoparticles have a mean particle size ranging from about 20 nm to about 30 nm. In some embodiments, the vanadium oxide nanoparticles have a mean particle size ranging from about 25 nm to about 30 nm. In some embodiments, the vanadium oxide nanoparticles have a mean particle size of about 25 nanometers. In some embodiments, there is an interconnected network of vanadium oxide nanoparticles of differing particle size. In some embodiments, the graphene scaffold comprises an oxygen-containing functional group comprising C—O, C—O—C, C═O, or COOH. In some embodiments, the vanadium oxide nanoparticles are anchored to the graphene scaffold. In some embodiments, the vanadium oxide nanoparticles are anchored to the graphene scaffold at the oxygen-containing functional group. In some embodiments, the vanadium oxide nanoparticles are configured to improve the migration of an electrolyte ion into an active site of the electrode. In some embodiments, the laser scribing produces conductive graphene scaffold comprising vanadium oxides with multiple oxidation states in one step.

Aspects disclosed herein provide a method of producing an energy storage device comprising: providing an electrode material comprising a graphene scaffold, the graphene scaffold comprising a three-dimensional network of interconnected pores, a first vanadium oxide in a first oxidation state, and a second vanadium oxide in a second oxidation state; inserting an electrolyte into the device; contacting the electrode material with at least one current collector; and sealing the device. In some embodiments, the method includes providing two layers of the electrode material, and inserting the electrolyte such that it is contact with each layer. In some embodiments, inserting an electrolyte into the device comprises contacting a separator with the electrolyte and inserting the separator into the device. In some embodiments, the electrolyte comprises LiCl. In some embodiments, the electrolyte is a gelled electrolyte. In some embodiments, the electrolyte is a gelled electrolyte comprises LiCl/PVA. In some embodiments, the LiCl/PVA is formed by adding PVA powder to an aqueous solution, heating to about 90° C., adding LiCl, stirring the solution, and cooling to room temperature. In some embodiments, inserting an electrolyte into the device comprises applying the LiCl/PVA to each electrode and a separator and inserting the separator between two layers of the electrode material. In some embodiments, the laser scribing produces conductive graphene scaffold comprising vanadium oxides with multiple oxidation states in one step.

Those skilled in the art will appreciate the scope of the present disclosure and realize additional aspects thereof after reading the following detailed description in association with the accompanying drawings.

### BRIEF DESCRIPTION OF THE DRAWINGS

The features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIGS. 1A to 1D illustrate an exemplary method of fabricating laser-scribed graphene/vanadium oxide (LSG/VOₓ) composite electrodes, per one or more embodiments herein;

FIG. 1A is a schematic diagram showing an exemplary electrode fabrication process, per one or more embodiments herein;

FIGS. 1B and 1C are optical images of an exemplary LSG/VOₓ film coated on a silicon wafer and a large sheet of graphite paper, per one or more embodiments herein;

FIG. 1D is an optical image of an exemplary LSG/VOₓ film on a transparent plastic substrate showing the composite before (bottom) and after (top) laser irradiation, per one or more embodiments herein;

FIGS. 2A to 2D provides a characterization of an exemplary graphene oxide/vanadium chloride (GO/VCl₃) film, per one or more embodiments herein;

FIGS. 2A to 2C are low-magnification and high-magnification scanning electron microscope (SEM) images of an exemplary GO/VCl₃ film, per one or more embodiments herein;

FIG. 2D shows an x-ray diffraction (XRD) pattern of an exemplary GO/VCl₃ film, per one or more embodiments herein;

FIGS. 3A to 3F show microscopic and spectroscopic images of an exemplary LSG/VOₓ composite (VCl₃:GO=4:1), per one or more embodiments herein;

FIGS. 3A and 3B are low-magnification and high-magnification SEM images of an exemplary LSG/VOₓ composite, per one or more embodiments herein;

FIG. 3C is a transmission electron microscope (TEM) image showing exemplary VOₓ particles on graphene, per one or more embodiments herein;

FIG. 3D is a high-magnification TEM image of an exemplary VOₓ network, per one or more embodiments herein;

FIG. 3E is an XRD pattern of an exemplary composite comprising V₂O₃, VO₂, and mixed-valence vanadium oxides, per one or more embodiments herein;

FIG. 3F shows an X-ray photoelectron spectroscopy (XPS) V 2p spectrum of an exemplary LSG/VOₓ composite, per one or more embodiments herein;

FIGS. 4A to 4F are micrographs showing low-magnification and high-magnification SEM images of an exemplary LSG/VOₓ composite electrode, per one or more embodiments herein;

FIG. 5A is an exemplary TEM image showing VOₓ particles on a graphene sheet, per one or more embodiments herein;

FIG. 5B is a plot showing an exemplary size distribution of VOₓ particles based on FIG. 3C, per one or more embodiments herein;

FIG. 5C is a higher-magnification TEM image of an exemplary VOₓ network, per one or more embodiments herein;

FIGS. 6A and 6B are graphs showing XPS O 1s and C Is spectra, respectively, of an exemplary LSG/VOₓ composite, per one or more embodiments herein;

FIGS. 7A to 7C show graphs of electrochemical measurements of an exemplary LSG/VOₓ composite in a three-electrode setup, per one or more embodiments herein;

FIG. 7A shows galvanostatic charge/discharge (GCD) curves of an exemplary LSG/VOₓ with different VCl₃:GO ratios at 1 mA cm 2, per one or more embodiments herein;

FIG. 7B shows the gravimetric capacitance of an exemplary LSG/VOₓ with different precursor VCl₃:GO ratios at a range of scan rates, per one or more embodiments herein;

FIG. 7C shows cyclic voltammetry (CV) curves of an exemplary LSG/VOₓ at 5, 10, 20, 50, 100, and 200 mV s⁻¹, per one or more embodiments herein;

FIG. 8A is a CV graph of an exemplary LSG/VOₓ and an exemplary LSG in 10.0 M lithium chloride (LiCl) compared with that of LSG and graphite paper in an electrolyte of 0.81 mM VCl₃ and 10.0 M LiCl at 20 mV s⁻¹, per one or more embodiments herein;

FIG. 8B is a CV graph of an exemplary LSG and graphite paper in an electrolyte of 0.81 mM VCl₃ and 10.0 M LiCl at 20 mV s⁻¹ (zoomed-in version of FIG. 8A), per one or more embodiments herein;

FIGS. 9A to 9E show comparisons between an exemplary laser-irradiated LSG/VOₓ and traditional reduced graphene oxide/vanadium trioxide (rGO/V₂O₃) electrodes, per one or more embodiments herein;

FIG. 9A is a schematic contrasting conventional techniques and laser scribing for the preparation of redox-active composite electrodes based on vanadium oxides and graphene, per one or more embodiments herein;

FIGS. 9B and 9C are cross-sectional SEM images of an exemplary rGO/V₂O₃ and LSG/VOₓ electrodes, per one or more embodiments herein;

FIG. 9D shows CV curves of an exemplary LSG/VOₓ and an exemplary rGO/V₂O₃ at 1 mV s⁻¹ showing several redox peaks, per one or more embodiments herein;

FIG. 9E is a Nyquist impedance plot of an exemplary LSG/VOₓ and an exemplary rGO/V₂O₃ electrodes with the high-frequency region in the inset, per one or more embodiments herein;

FIG. 10A is a graph showing GCD curves of an exemplary aqueous LSG/VOₓ at 1, 2, 5, and 10 A/g in a three-electrode setup, per one or more embodiments herein;

FIG. 10B is an image of an exemplary electrolyte after measurement (left) and fresh electrolyte (right), per one or more embodiments herein;

FIGS. 10C and 10D show Nyquist and Bode impedance plots of an exemplary LSG/VOₓ, respectively, per one or more embodiments herein;

FIGS. 11A to 11F illustrate electrochemical measurements of an exemplary aqueous 10 M LiCl LSG/VOₓ symmetric supercapacitor (SSC), per one or more embodiments herein;

FIG. 11A is a graph showing CV curves of an exemplary aqueous LSG/VOₓ SSC at 20, 40, 50, 60, and 100 mV s⁻¹, per one or more embodiments herein;

FIG. 11B is a graph showing GCD curves of an exemplary aqueous LSG/VOₓ SSC at 0.5, 1, 2, 3, 5, and 10 A/g, per one or more embodiments herein;

FIG. 11C is a graph showing gravimetric and areal capacitance of an exemplary aqueous LSG/VOₓ SSC at various scan rates, per one or more embodiments herein;

FIG. 11D is a graph showing gravimetric energy and power densities of an exemplary aqueous LSG/VOₓ SSC at various scan rates, per one or more embodiments herein;

FIG. 11E is a drawing showing two exemplary aqueous LSG/VOₓ SSCs connected in series to power a red light-emitting diode (LED) for an extended period of time, per one or more embodiments herein;

FIG. 11F is a graph showing the long-term stability of an exemplary aqueous LSG/VOₓ SSC after 20,000 cycles, per one or more embodiments herein;

FIGS. 12A to 12I illustrate electrochemical measurements of an LiCl/PVA quasi-solid-state LSG/VOₓ symmetric supercapacitor, per one or more embodiments herein;

FIG. 12A is a graph showing CV curves of an exemplary gel LSG/VOₓ SSC at 20, 40, 50, 60, and 100 mV s⁻¹, per one or more embodiments herein;

FIGS. 12B and 12C are graphs showing GCD curves of an exemplary aqueous LSG/VOₓ SSC at 40, 30, 20, 13, 10, 6, 5, 4, 3, 2, 1, and 0.5 A/g, per one or more embodiments herein;

FIG. 12D is a graph showing gravimetric and areal capacitance of an exemplary gel LSG/VOₓ SSC at various scan rates, per one or more embodiments herein;

FIG. 12E is a graph showing gravimetric energy and power densities of an exemplary gel LSG/VOₓ SSC at various scan rates, per one or more embodiments herein;

FIG. 12F is a graph showing Coulombic efficiency of an exemplary gel LSG/VOₓ SSC at various scan rates, per one or more embodiments herein;

FIG. 12G is a Nyquist impedance plot comparing an exemplary aqueous and an exemplary gel LSG/VOₓ SSC with the high-frequency region in the inset, per one or more embodiments herein;

FIG. 12H is a graph showing long-term stability of an exemplary 1.5 V gel LSG/VOₓ SSC after 10,000 cycles compared with an exemplary aqueous LSG/VOₓ SSC, per one or more embodiments herein;

FIG. 12I is drawings showing two exemplary gel LSG/VOₓ SSCs connected in series that power blue, green, and red LEDs for extended periods of time, per one or more embodiments herein;

FIG. 13A illustrates an XRD pattern of an exemplary rGO/V₂O₃ mixture matching V₂O₅ 1.6 H₂O, per one or more embodiments herein;

FIG. 13B is a graph showing CV curves of an exemplary rGO/V₂O₃ electrode at 500, 400, 300, 200, 100, 80, and 50 mV s⁻¹ in a three-electrode setup, per one or more embodiments herein;

FIG. 13C is a graph showing GCD curves of an exemplary rGO/V₂O₃ electrode at 8, 6, 4, 2, 1, and 0.5 A/g in a three-electrode setup, per one or more embodiments herein;

FIGS. 13D and 13E are graphs showing CV curves of the exemplary rGO/V₂O₃ SSC at various scan rate, per one or more embodiments herein;

FIG. 13F is a Nyquist impedance plot of exemplary LSG/VOₓ and exemplary rGO/V₂O₃ electrodes with the high-frequency region shown in the inset, per one or more embodiments herein;

FIGS. 14A to 14F illustrate electrochemical measurements of an exemplary aqueous 10 M LiCl LSG/VOₓ SSC, per one or more embodiments herein;

FIG. 14A is a graph showing CV curves of an exemplary aqueous LSG/VOₓ SSC at 1,000, 500, 300, 250, 200, and 150 mV s⁻¹, per one or more embodiments herein;

FIG. 14B is a graph showing CV curves of an exemplary aqueous LSG/VOₓ SSC at 10, 8, 6, 5, 2, and 1 mV s⁻¹, per one or more embodiments herein;

FIG. 14C is a Nyquist plot of an exemplary LSG/VOₓ SSC, per one or more embodiments herein;

FIG. 14D is a graph showing GCD curves of an exemplary aqueous LSG/VOₓ SSC at 60, 50, 40, 33, 25, and 20 A/g, per one or more embodiments herein;

FIG. 14E is a graph showing gravimetric and areal capacitance of an exemplary aqueous LSG/VOₓ SSC at various current densities, per one or more embodiments herein;

FIG. 14F is a graph showing gravimetric energy and power densities of an exemplary aqueous LSG/VOₓ SSC at various current densities, per one or more embodiments herein;

FIGS. 15A to 15E illustrate electrochemical measurements of an exemplary quasi-solid-state LiCl/PVA LSG/VOₓ SSC, per one or more embodiments herein;

FIG. 15A is a graph showing CV curves of an exemplary aqueous LSG/VOₓ SSC at 1,000, 500, 300, 250, 200, and 150 mV s⁻¹, per one or more embodiments herein;

FIG. 15B is a graph showing CV curves of an exemplary aqueous LSG/VOₓ SSC at 10, 8, 6, 5, 2, and 1 mV s⁻¹, per one or more embodiments herein;

FIG. 15C is a graph showing the gravimetric and areal capacitance of an exemplary aqueous LSG/VOₓ SSC at various current densities, per one or more embodiments herein;

FIG. 15D is a graph showing gravimetric energy and power densities of an exemplary aqueous LSG/VOₓ SSC at various current densities, per one or more embodiments herein;

FIG. 15E is a graph showing CV curves of an exemplary quasi-solid-state LSG/VOₓ SSC when flat and bent; the inset is a diagram of an SSC bent around a 50 mL Falcon tube, per one or more embodiments herein;

FIGS. 16A to 16D illustrate a comparison of the performance of exemplary LSG/VOₓ supercapacitors with commercially available energy storage devices, per one or more embodiments herein;

FIG. 16A is a plot of operating potential and gravimetric capacitance comparing the exemplary LSG/VOₓ devices with similar systems in the literature, per one or more embodiments herein;

FIG. 16B is a Ragone plot comparing the gravimetric energy and power densities of exemplary LSG/VOₓ SSCs with those of other vanadium oxide systems reported in the literature, per one or more embodiments herein;

FIG. 16C is a Ragone plot comparing the volumetric energy and power densities of exemplary LSG/VOₓ SSCs with other vanadium oxide systems reported in the literature, per one or more embodiments herein;

FIG. 16D is a Ragone plot comparing the volumetric energy and power densities of exemplary LSG/VOₓ SSCs to commercial energy storage devices, per one or more embodiments herein;

FIG. 17 is a graph showing thermal gravimetric analysis measurements to determine the weight percent of VOₓ in the active material at a rate of 5° C. min⁻¹ in air, per one or more embodiments herein;

FIGS. 18A to 18E illustrate electrochemical measurements of an exemplary 1.7 V quasi-solid-state LSG/VOₓ SSC, per one or more embodiments herein;

FIG. 18A is a graph showing CV curves of an exemplary aqueous LSG/VOₓ SSC at 20, 40, 50, 60, and 100 mV s⁻¹, per one or more embodiments herein;

FIG. 18B is a graph showing GCD curves of an exemplary aqueous LSG/VOₓ SSC at 0.5, 1, 3, 10, and 20 A/g, per one or more embodiments herein;

FIG. 18C is a graph showing gravimetric and areal capacitance of an exemplary aqueous LSG/VOₓ SSC at various scan rates, per one or more embodiments herein;

FIG. 18D is a graph showing gravimetric energy and power densities of an exemplary aqueous LSG/VOₓ SSC at various scan rates, per one or more embodiments herein;

FIG. 18E is a graph showing the long-term stability of an exemplary aqueous LSG/VOₓ SSC after 10,000 cycles, in comparison with the aqueous system, per one or more embodiments herein;

FIGS. 19A to 19F illustrate electrochemical measurements of an exemplary aqueous 10 M LiCl rGO//LSG/VOₓ asymmetric supercapacitor (ASC), per one or more embodiments herein;

FIG. 19A is a graph showing CV curves of an exemplary aqueous rGO//LSG/VOₓ ASC at 400, 300, 250, 200, 150, and 100 mV s⁻¹, per one or more embodiments herein;

FIG. 19B is a graph showing GCD curves of an exemplary aqueous rGO//LSG/VOₓ ASC at 0.8, 1, 1.5, 2, 3, and 5 A/g, per one or more embodiments herein;

FIG. 19C is a Bode plot of an exemplary aqueous rGO//LSG/VOₓ ASC, per one or more embodiments herein;

FIG. 19D is a graph showing gravimetric and areal capacitance of an exemplary aqueous LSG/VOₓ SSC at various scan rates, per one or more embodiments herein;

FIG. 19E is a graph showing gravimetric energy and power densities of an exemplary aqueous rGO//LSG/VOₓ ASC at various scan rates, per one or more embodiments herein;

FIG. 19F is a graph showing the long-term stability of an exemplary aqueous LSG/VOₓ SSC after 10,000 cycles, per one or more embodiments herein;

FIG. 20 is a Ragone plot comparing the volumetric energy and power densities of exemplary LSG/VOₓ SSCs with other vanadium oxide systems reported in the literature, normalized to active material volume, per one or more embodiments herein;

FIG. 21A illustrates an exemplary laser-scribed graphene-vanadium oxide for high rate cathodes, per one or more embodiments herein;

FIG. 21B illustrates the nanoscale mechanism of using cryogenic electron microscopy, per one or more embodiments herein;

FIG. 22 is a Ragone plot comparing the gravimetric energy and power densities of an exemplary LSG/VOₓ supercapacitors with those of other vanadium oxide systems reported in the literature, per one or more embodiments herein;

FIG. 23 is a diagram of a cryo-transfer method and atomic-resolution of a lithium metal lattice, per one or more embodiments herein.

### DETAILED DESCRIPTION

Supercapacitors have been a prevalent area of research during the past decade due to their remarkable high power density and long cycle life. Although supercapacitors are considered to bridge the gap between traditional capacitor-type and battery-type electrochemical charge storage devices, the relatively low energy density of supercapacitors remains their major impediment to be widely utilized in commercial applications. The energy density of a device is directly proportional to its specific capacitance and the square of the operating voltage. Therefore, a rational design to efficiently improve supercapacitor energy density must aim to maximize both. Electric double-layer capacitance (EDLC) and pseudocapacitance are the two charge/discharge mechanisms on which supercapacitors rely. The former comes from the physical accumulation of electrostatic charge at the electrode-electrolyte interface, and the latter depends on fast Faradaic reactions that occur at or near the electrode surface. Thus, to achieve the best possible electrochemical performance, the electrode should be a hybrid material with not only a structure of high specific area but also a redox-active chemical composition, taking advantage of both capacitive processes.

The theoretical specific capacitance of a pseudocapacitive electrode is proportional to the number of electrons involved in a specific redox reaction. Transition metal oxides with fast and reversible redox couples are excellent candidates for pseudocapacitors, and many have been verified to show pseudocapacitive behavior, such as RuO₂, MnO₂, Co₃O₄, and Fe₃O₄. While most transition metal oxides only have two interconvertible oxidation states, vanadium oxides (VOₓ) possess four readily accessible valence states (II-V), making them especially promising for high pseudocapacitance. Among all types of vanadium oxides, V₂O₅ has been studied the most for energy storage applications; however, there are benefits to employing mixed-valence VOₓ, since VO₂ and V₂O₃ have higher electrical conductivities than V₂O₅, and the pre-existing multiple oxidation states are likely to provide a larger electrochemical active potential window. For example, a valence optimized VOₓ electro-oxidized from V₂O₃ increased its potential window from 0.5 V for pure V₂O₃ to 0.8 V after an electro-oxidized modification.

Although vanadium oxides are earth-abundant and economical, many may have relatively high resistivity in comparison with the much more expensive RuO₂. A common approach to compensate for the poor conductivity of pseudocapacitive vanadium oxides is the incorporation of carbon-based materials, for example, reduced graphene oxide (rGO), carbon nanotubes, and activated carbon. These highly conductive carbonaceous materials generally exhibit EDLC behavior; thus, it is favorable to adopt high porosity morphologies so that the specific active area for storing charge at the electrode surface may be maximized. The synthesis of a carbon-vanadium oxide composite may typically be a multi-step process that involves either separate pre-functionalization of the carbon-based material or post-assembly high-temperature modification via solvothermal treatment or calcination. For instance, in a micelle-assisted synthesis of V₂O₃@C composites the vanadate coats the pre-treated activated carbon and subsequently undergoes calcination, attaining a specific capacitance of 205 F/g with a 1 V window. Despite the delicate core-shell designs, the electrode exhibited a large charge transfer resistance (Ra) of 16.3Ω and a long time constant of ˜32 s, and the power density fell below 20 W kg⁻¹ at the maximum energy density. Evidently, it is challenging to obtain a high-performance composite electrode with good electronic and ionic conductivity without a three-dimensional charge transfer network. A self-assembled rGO/V₂O₅ aerogel symmetric supercapacitor possesses 68 W h kg⁻¹ at a power density of 250 W kg⁻¹; however, the synthesis requires a 2-day gelation followed by freeze-drying and thermal annealing. Also, the addition of a binder is required to maintain the structural integrity of the electrode, and the electrochemical measurements were done in the voltage range of −1 V to 1 V, which is impractical for commercial devices. A simple one-step laser-scribing process can reliably produce porous laser-scribed graphene (LSG) thin films and simultaneously yield metal oxides. The as-synthesized LSG network can provide a highly conductive EDLC scaffold for the nanosized VOₓ particles, due to its electrical semi-metallicity and mechanical rigidity.

The present disclosure relates to an LSG/VOₓ nanocomposite hybrid electrode synthesized via a facile laser-scribing process from graphite oxide (GO) and VCl₃ precursors. Mediated by the Coulombic attraction between the negatively charged oxygen surface groups and positively charged vanadium cations, the VOₓ nanoparticles are directly anchored onto the three-dimensional LSG scaffold. This enables both the pseudocapacitive and the EDLC components to be readily accessible to the electrolyte. The high local temperature generated during laser scribing simultaneously accomplishes the reduction of GO and the entropy-driven formation of multivalent VOₓ. By starting from the low-valent V(III) precursor, the composition of the as-synthesized VOₓ is dominated by the relatively less resistive V₂O₃, and with the incorporation of the LSG network, the LSG/VOₓ nanocomposite electrode can obtain a high specific capacitance of 1,110 F/g with a very small R_{ct} in a three-electrode setup. The LSG/VOₓ electrode has a large electrochemically active potential window and may be assembled into aqueous symmetric supercapacitors (SSCs) with a 1.3 V window, accredited to the presence of multiple oxidation states. The LSG/VOₓ SSCs can attain a high energy density of 54 Wh/kg at a power density of 894 W kg⁻¹ with outstanding capacitance retention of 112% after 20,000 cycles. Furthermore, quasi-solid-state LSG/VOₓ SSCs with a gel electrolyte were also fabricated to increase the operating voltage. With R_{ct}<0.02Ω and Coulombic efficiency close to 100% at all scan rates, the 1.5 V flexible gel LSG/VOₓ SSC reached a high energy density of 72 Wh/kg at a power density of 370 W kg⁻¹ with excellent capacitance retention of 92% after 20,000 cycles, placing it as one of the best-performing systems among those reported in the literature. Both LSG/VOₓ SSCs also demonstrate superior volumetric energy storage behavior in comparison with commercial devices.

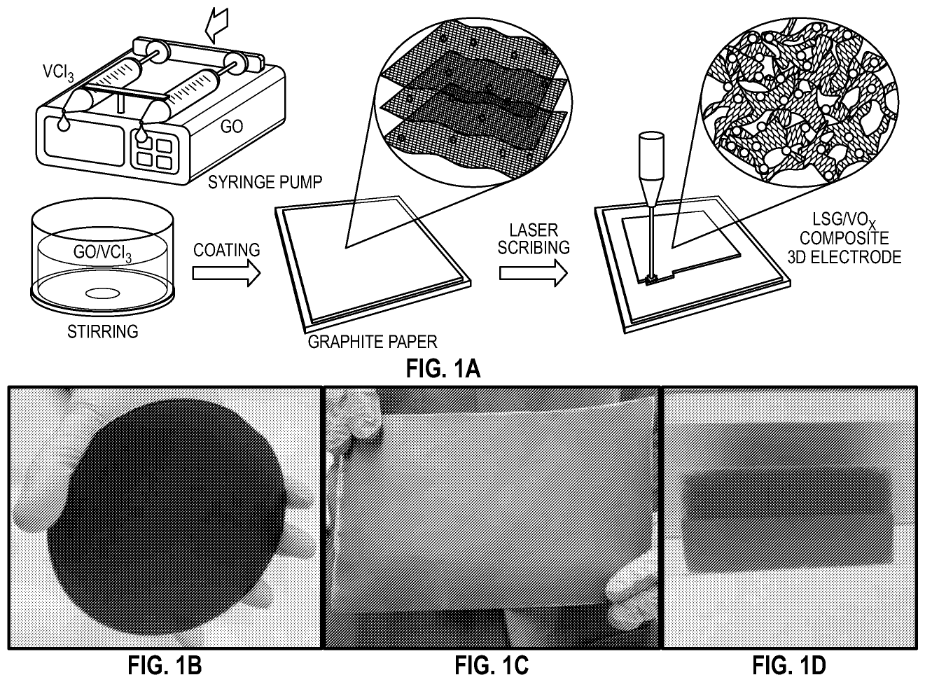

The LSG/VOₓ composite was synthesized by a laser-scribing process in which the reduction of GO and the conversion of VCl₃ to VOₓ took place simultaneously. A solution of precursor VCl₃ was gradually added to a GO suspension at a controlled rate through a syringe pump to create a stable mixture of GO/VCl₃. The GO acts as a framework to prevent the aggregation of vanadium species, while the vanadium particles serve as spacers to hinder the restacking of GO sheets due to the attractive Coulombic forces between V³⁺ and the negatively charged GO surfaces. The dried film then underwent laser scribing by a CO₂ laser under ambient atmosphere, instantaneously yielding VOₓ and structurally expanded LSG due to the locally induced heat that expels gaseous by-products such as H₂O and CO₂. The as-synthesized LSG/VOₓ composite films were used as electrodes without further processing (FIG. 1A). The concentration of the VCl₃ solution was varied to find the optimal loading for the composite electrodes.

As shown in FIGS. 1B and 1C, the LSG/VOₓ composite may readily be scaled up and coated onto large-area substrates such as a silicon wafer and an A5-size graphite paper, enabling the design of micro-supercapacitor arrays. To contrast the composite film before and after laser irradiation, the mixture was coated onto a clear polyethylene terephthalate (PET) substrate, illustrating that the dark violet film turns completely black upon exposure to the laser (FIG. 1D).

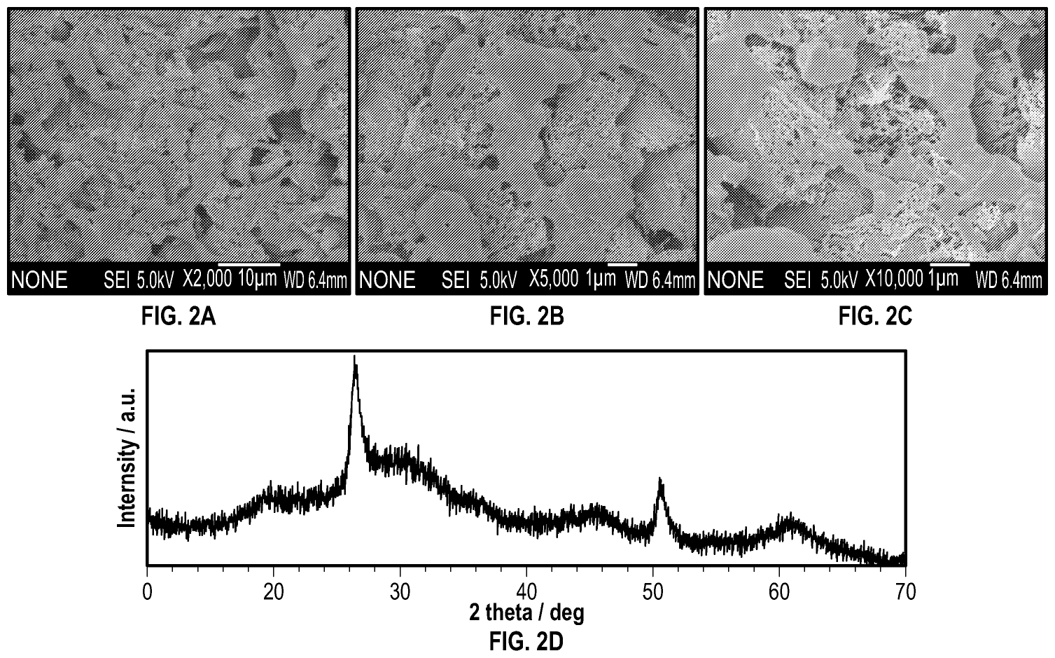

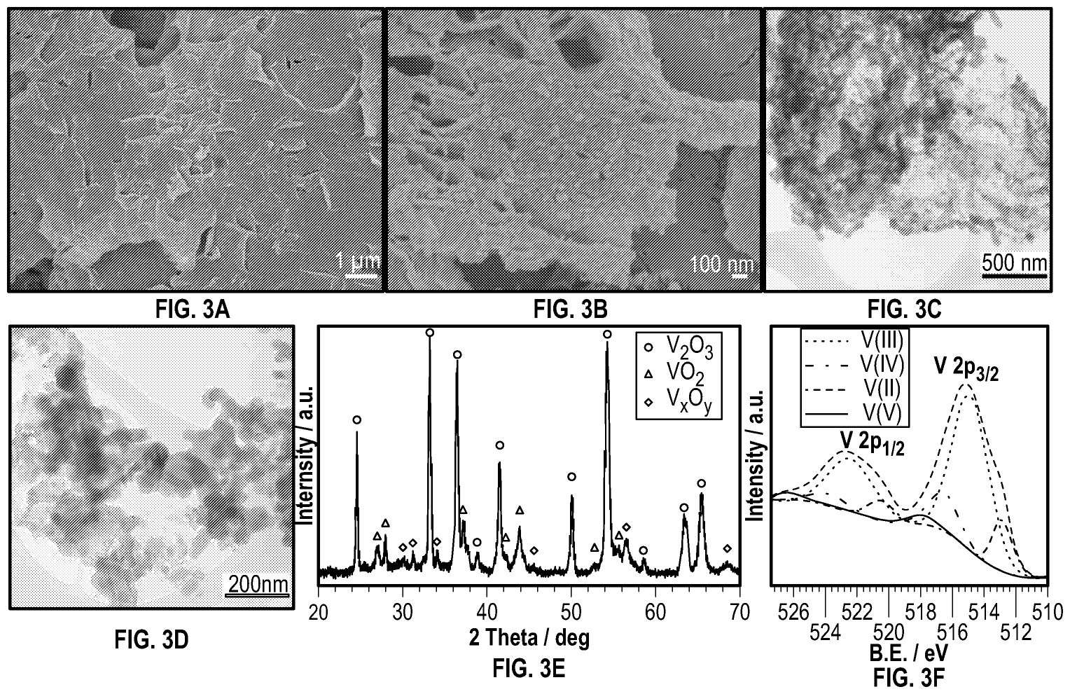

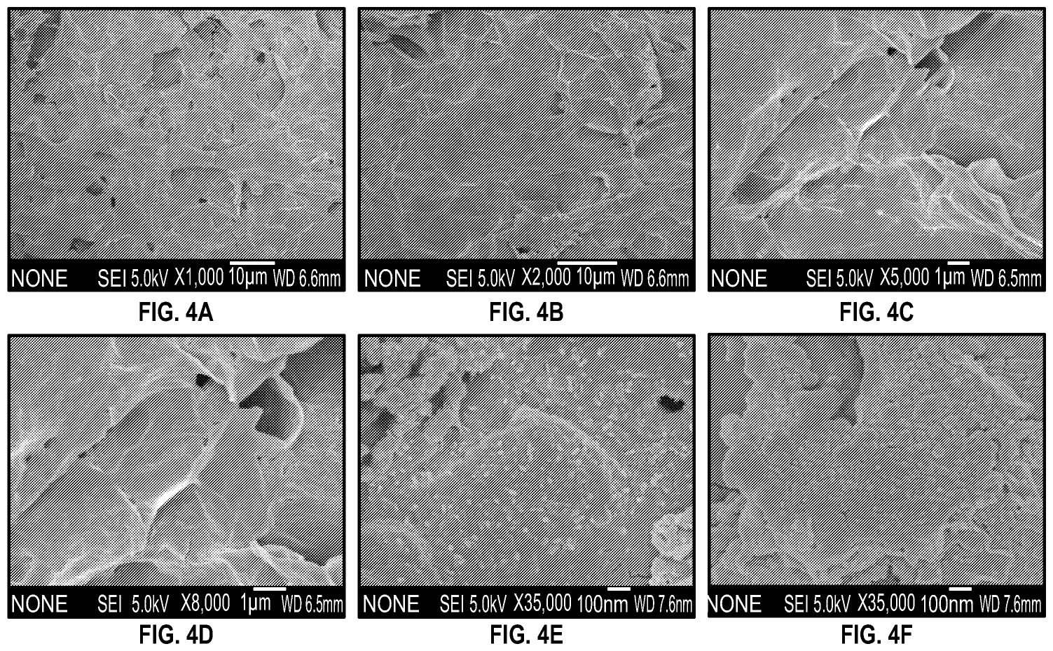

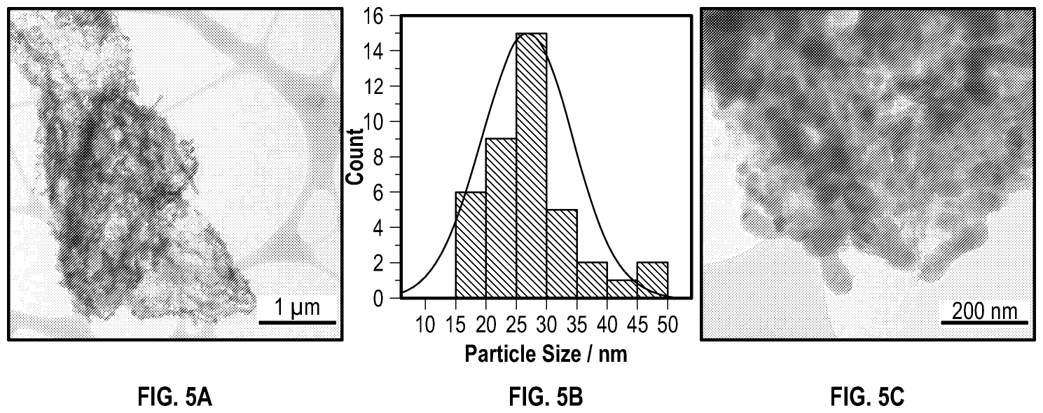

The structure and morphology of the LSG/VOₓ composite were characterized by scanning electron microscopy (SEM) and transmission electron microscopy (TEM). In comparison with the SEM images of the unprocessed GO/VCl₃ film in FIGS. 2A to 2C, FIG. 3A and FIGS. 4A to 4F show the typical morphology of rGO with flakes and wrinkles, confirming the successful reduction of GO by the laser-scribing process. Under higher magnification, FIG. 3B demonstrates that the VOₓ particles are uniformly coated over the three-dimensional LSG scaffold, providing numerous pathways for charge transfer. The network that is created upon laser reduction provides diffusion pathways for the intercalation of electrolyte cations. Also evident is that the restacking of rGO sheets is effectively inhibited by the VOₓ nano-spacers. As revealed by TEM images, the evenly distributed VOₓ particles are tightly bonded to the LSG surfaces; this is expected as the vanadium cations are attracted to the negatively charged LSG oxygen functional groups. Although the density of the VOₓ particles on the LSG sheets is high, the highly conductive graphene surfaces remain accessible for charge transfer from and to the electrolyte (FIG. 3C). While some VOₓ exists as individual nanoparticles with a mean size of ˜25 nm (FIGS. 5A to 5C), a significant proportion of them exist as connected networks of VOₓ (FIG. 3D). This is likely the result of both the high concentration of VCl₃ precursor and the high local temperature induced by the CO₂ laser.

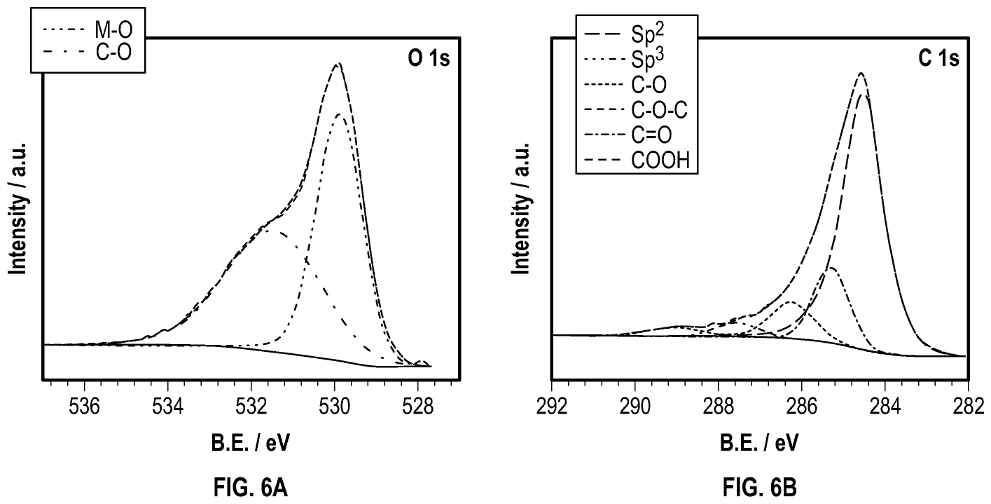

The vanadium valence states present in the LSG/VOₓ composite were analyzed by X-ray powder diffraction (XRD) and X-ray photoelectron spectroscopy (XPS). The strong diffraction peaks in the XRD pattern (FIG. 3E) of the LSG/VOₓ nanocomposite suggest the presence of vanadium oxides. Specifically, the sharp peaks at 24.4°, 33.2°, 36.4°, and 54.2° may be indexed to the (012), (104), (110), and (116) of karelianite V₂O₃ with the rhombohedral corundum-type structure, indicating that it is the major vanadium oxide species present. There is also a much smaller amount of VO₂ present, and the remaining proportion consists of several non-stoichiometric vanadium oxides. Compared with the weakly diffracting GO/VCl₃ mixture that only shows a significant (002) graphitic peak at 26.4° (FIG. 2D), the transformation of VCl₃ to VOₓ during the laser-scribing process is verified by the XRD patterns. As shown by the XPS spectrum (FIG. 3F), the broad V 2p peaks indicate the presence of multiple vanadium valence states. The profile fits indicate that the V 2p_{3/2} V(III) peak at 514.9 eV accounts for 69.9 at. % of all the vanadium present. This suggests that the major oxidation state is +3, consistent with the predominant peaks of V₂O₃ in the XRD patterns. The V 2p_{3/2} V(IV) peak at 516.5 eV, representing 14.3% of the total vanadium content, may be attributed to VO₂. The non-stoichiometric vanadium oxides and the defects in V₂O₃ and VO₂ also give rise to the V 2p_{3/2} V(II) and V(V) peaks at 512.9 eV and 517.9 eV, respectively. The O 1s region shows not only a C—O peak but also a metal oxide peak at 529.9 eV, confirming the formation of VOₓ (FIG. 6A). The C Is peak is dominated by the sp² contribution with residual oxygen-containing groups present, confirming the reduction of GO (FIG. 6B). In summary, all evidence from SEM, TEM, XPS, and XRD indicates the simultaneous formation of VOₓ and LSG during the laser-scribing process, as described by FIG. 1A.

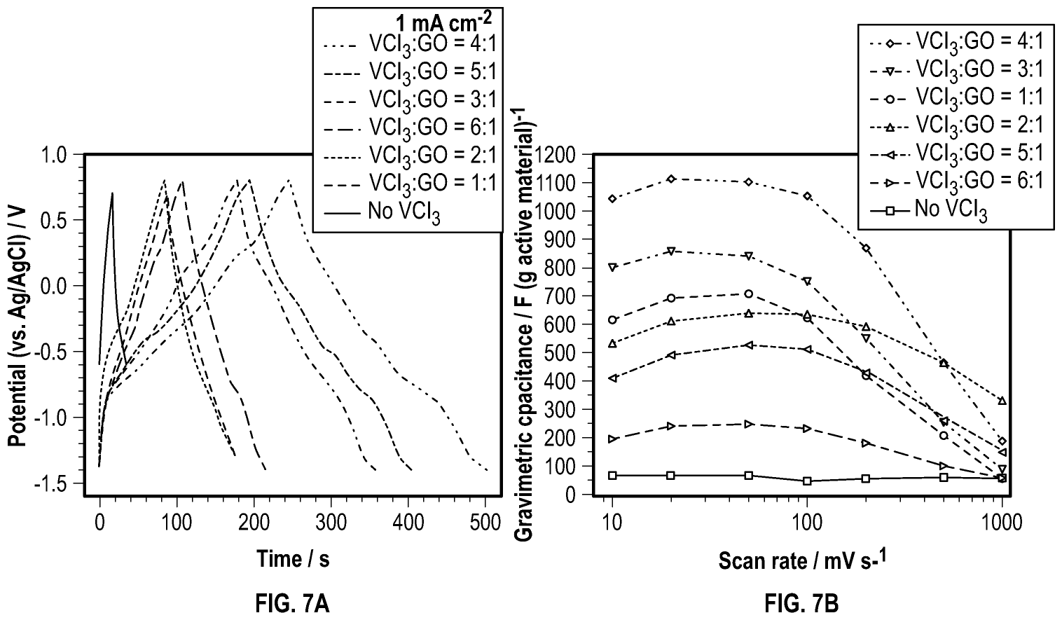

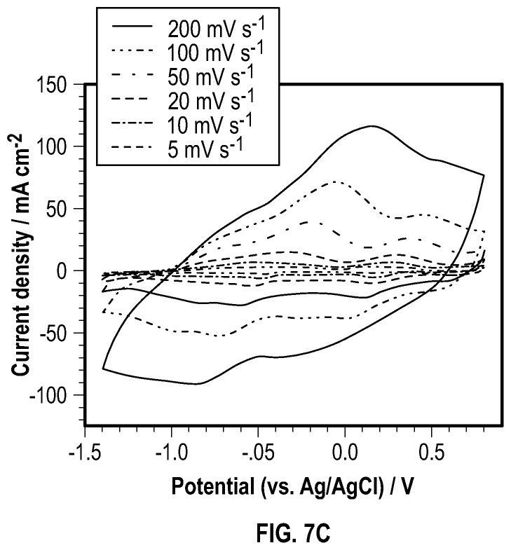

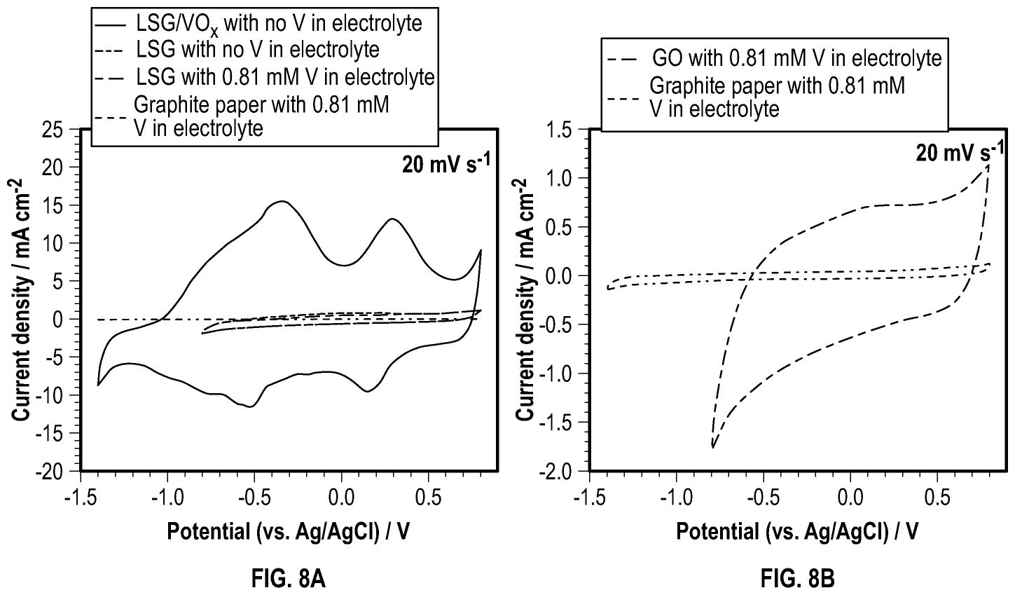

The electrochemical properties of the LSG/VOₓ electrodes were evaluated in a three-electrode setup with an Ag/AgCl reference electrode and a graphite counter electrode in 10 M LiCl electrolyte. First, the starting VCl₃:GO precursor mass ratio was varied to find the optimal content of vanadium in the nanocomposite in terms of capacitive performance. The galvanostatic charge/discharge (GCD) curves at 1 mA cm⁻² for the LSG/VOₓ nanocomposites with different VCl₃:GO ratios are shown in FIG. 7A. At a low current density, all samples may be steadily charged from −1.4 V to 0.8 V (vs. Ag/AgCl) with observable redox plateaus, except for those with VCl₃:GO=1 and no VCl₃ that have smaller potential windows of −1.3 V to 0.7 V (vs. Ag/AgCl) and −0.6 V to 0.7 V (vs. Ag/AgCl). This indicates that the large electrochemically active voltage window may be attributed to the high VOₓ loading in the electrode. FIG. 7B summarizes the capacitance that is calculated based on cyclic voltammetry (CV) curves at a range of scan rates and normalized to the active material mass of the electrodes made from the different VCl₃:GO ratios. All electrodes with any addition of VCl₃ have increasing capacitance as the scan rate falls, suggesting that the capacitance is dominated by the pseudocapacitive contribution from the redox reactions of VOₓ. At scan rates below 1 V s⁻¹, the nanocomposite electrode with VCl₃:GO=4 has the highest gravimetric capacitance, and this ratio is therefore determined to be the optimal precursor ratio and is used in later device fabrication. At 20 mV s⁻¹, the highest specific capacitance of 1,110 F/g was achieved (with areal mass loading of about 0.3 mg/cm²), which is nearly 20 times higher than the LSG with no vanadium content. This remarkable improvement may be ascribed to the LSG framework within which the pseudocapacitive VOₓ nano-spacers are anchored. This results in improved migration of electrolyte ions into active sites, enabling the VOₓ pseudocapacitance to be efficiently exploited. The nanocomposite with VCl₃:GO=4 is the best-performing electrode because there exists a favorable balance in which the VOₓ content is sufficiently high to provide substantial pseudocapacitance, while not being so excessive that access to the LSG scaffold is compromised due to significant VOₓ aggregations. As shown in FIG. 7C, the electrochemical behaviors of the LSG/VOₓ nanocomposite electrodes with the optimized VCl₃:GO=4 ratio were further investigated by CV. At scan rates from 200 mV s⁻¹ to 5 mV s⁻¹, the CV curves adopt a distorted rectangular shape with two pairs of broad redox peaks, suggesting pseudocapacitive behavior, which is further discussed subsequently. Furthermore, control experiments were carried out to simulate the scenario in which all vanadium content in the LSG/VOₓ electrode dissolved in the electrolyte. As shown in FIGS. 8A and 8B, neither the LSG nor the graphite paper substrate contribute significant capacitance in vanadium-containing electrolytes, confirming that the LSG/VOₓ electrode is the only significant source of the high capacitance.

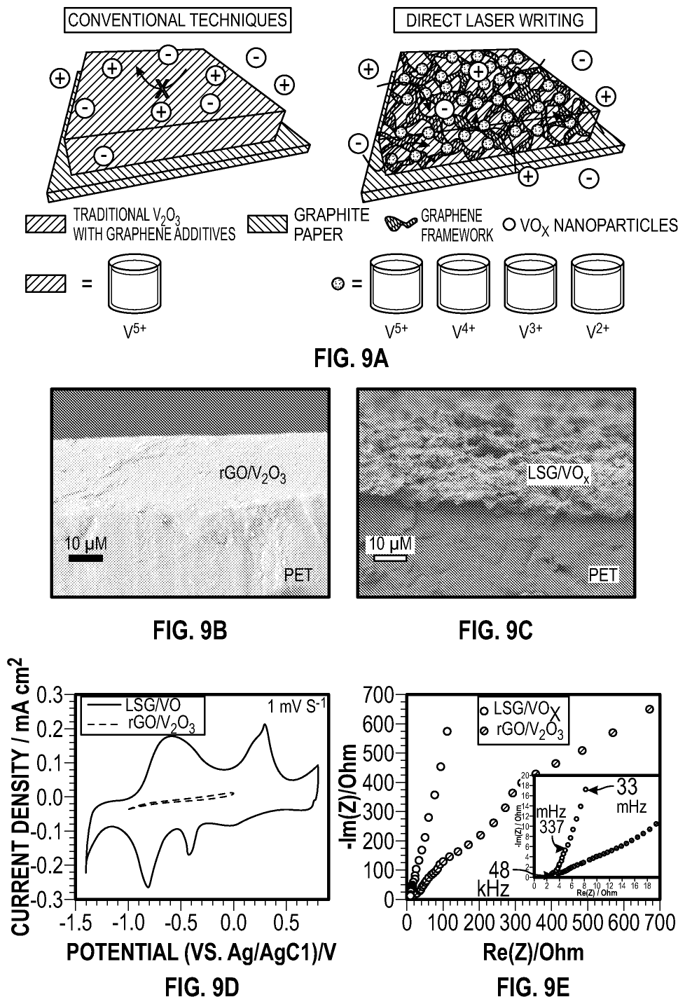

To demonstrate the advantages of the one-step laser process, the performance of the LSG/VOₓ electrode is compared with an electrode made simply from an rGO/V₂O₃ mixture. As shown in FIG. 9A, the laser scribing of the LSG/VCl₃ mixture not only creates a network for charge transfer but also provides nano-size vanadium oxides of various oxidation states and/or phases, compared with the rGO/V₂O₃ physical mixture made by conventional means. The cross-sectional SEM image of an rGO/V₂O₃ film on a polyethylene terephthalate substrate shows a completely stacked structure with no observable pores or layers (FIG. 9B). On the other hand, FIG. 9C illustrates the expanded and porous LSG scaffold supplying numerous pathways for charge transport. As shown by the orange curve in FIG. 9D, at a very low scan rate of 1 mV s⁻¹, it is revealed that there are multiple redox couples involved in the charge/discharge of the LSG/VOₓ electrode, which may be assigned to the near-surface Faradaic processes of multistep electrochemical exchanges among different vanadium valence states of VOₓ and lithium ion insertion into various probable VOₓ phases. The possible reaction involved can be represented by the following equation:

$$\\ {VO}_{x} + n {Li}^{+} + {ne}^{-} ↔ {Li}_{n} {VO}_{x}$$

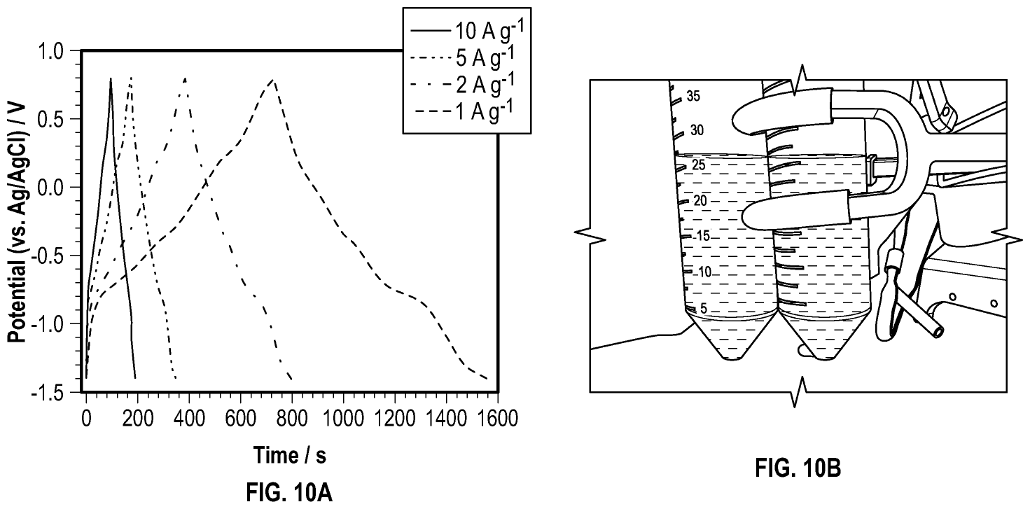

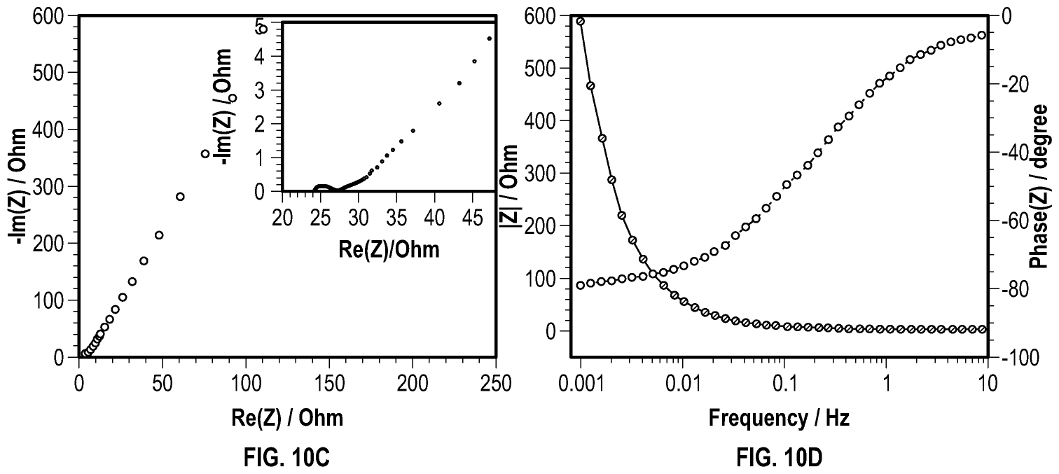

The asymmetric peaks in the positive potential region represent an irreversible redox reaction and may be attributed to the formerly reported chemical dissolution of vanadium oxide forming yellow-colored soluble species such as H₂VO₄⁻ and/or HVO₄²⁻ (FIG. 10B). Note that the major pseudocapacitive contributions are from the region between −1.3 V and 0.2 V (vs. Ag/AgCl), corroborating that V(III) is the primary vanadium oxidation state in the nanocomposite. Thus, in an ideal scenario, the aqueous LSG/VOₓ SSCs are expected to achieve the best capacitance and long cycle life by operating in the voltage window between −1.3 V and 0.2 V (vs. Ag/AgCl). In contrast, the green CV curve of the rGO/V₂O₃ electrode at 1 mV s⁻¹ shows no peaks at all and a significantly smaller area, indicating a lack of diverse vanadium valence states or structural phases. This is consistent with the XRD pattern of the rGO/V₂O₃ electrode that solely matches V₂O₅·1.6 H₂O (FIG. 8A), resulting from V₂O₃ oxidation in water.

Moreover, the electrochemical window of the rGO/V₂O₃ electrode is −1 V to 0 V vs. Ag/AgCl, which is dramatically smaller than that of the LSG/VOₓ electrode, leading to a much smaller capacitance of 17 F/g at 1 mV s⁻¹, which is about 1/100 of that of the LSG/VOₓ electrode. Furthermore, electrochemical impedance spectroscopy was used to assess the charge transport properties of the LSG/VOₓ and rGO/V₂O₃ electrodes (FIG. 9E). In FIG. 9E, the Nyquist plot of the LSG/VOₓ possesses a semicircle in the high-frequency region and a steep straight line in the low-frequency region, signifying a resistive and a capacitive component in the equivalent circuit, respectively. On the other hand, the Nyquist plot of the rGO/V₂O₃ electrode shows low phase angles that deviate from capacitive behavior even at high frequencies. As shown in the inset of FIG. 9E, the LSG/VOₓ electrode has much smaller equivalent series resistance and R_{ct} compared with the rGO/V₂O₃ electrode. The R_{ct} of the LSG/VOₓ electrode is 0.28Ω, based on the diameter of the semicircle, and the small R_{ct} may be ascribed to the LSG scaffold that provides both high electronic and ionic conductivity. FIG. 10C shows a Nyquist impedance plot of an exemplary LSG/VOₓ. The Bode plot (FIG. 10D) shows a phase angle of −79° at low frequencies, close to −90° expected for an ideal capacitor. The tilt of the CV curves, as well as the sizable iR drop in the GCD curves, also suggests the higher resistivity of the rGO/V₂O₃ electrode (FIG. 8B). Overall, due to the well-structured LSG platform and the multi-valency and phase diversity of the VOₓ nanoparticles, the LSG/VOₓ electrodes synthesized by laser writing possess considerably improved electrochemical properties compared with the physically mixed rGO/V₂O₃.

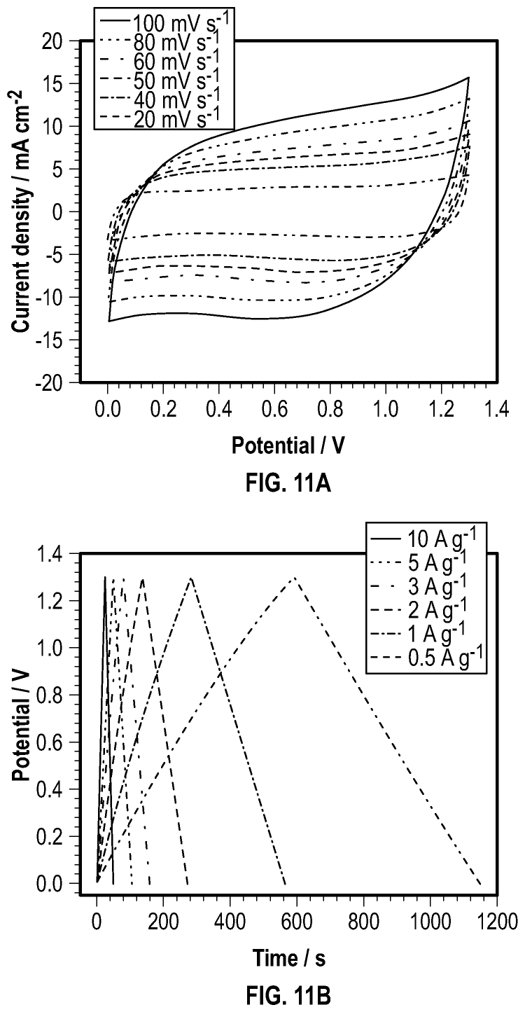

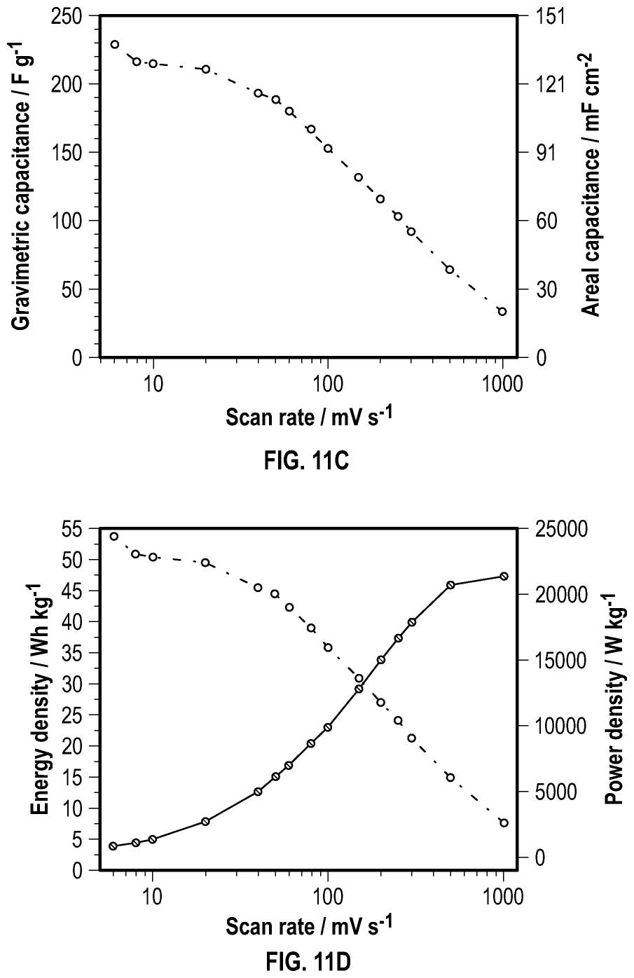

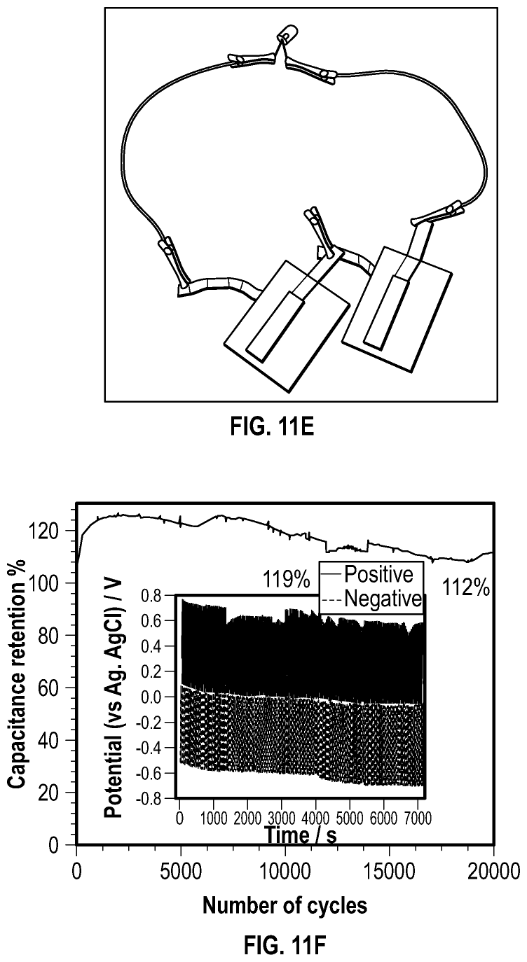

To assess the electrochemical performance of the LSG/VOₓ nanocomposite electrodes in a more practical setup, SSCs were fabricated from two LSG/VOₓ electrodes separated by a polymer separator in a 10 M LiCl electrolyte. The CV curves of the symmetric device show nearly rectangular shapes with a stable voltage window of 1.3 V and are consistent at different scan rates, indicating ideal energy storage behaviors (FIG. 11A). The GCD profiles also adopt triangular shapes with negligible iR drops and show that the devices can be steadily charged to 1.3 V even at a low current density of 0.5 A/g, confirming fast pseudocapacitive properties (FIG. 11B). FIGS. 11C and 11D summarize the gravimetric device capacitance, energy density, and power density calculated from CV curves at scan rates ranging from 1,000 mV s⁻¹ to 1 mV s⁻¹. At 6 mV s⁻¹, the device gravimetric capacitance can reach 229 F/g, with an energy density and power density of 54 Wh/kg and 894 W kg⁻¹, respectively. At a high scan rate of 1,000 mV s⁻¹, the SSC can achieve a power density of 21 kW kg⁻¹ (with an energy density of 2 Wh/kg). As demonstrated by FIG. 11E, LSG/VOₓ symmetric devices can power a red light-emitting diode (LED; 2.1 V, 20 mA) when two of them are connected in series. The LED remained bright for more than 10 minutes.

Unlike most supercapacitors based on vanadium oxides that may only retain their peak performance for the first few thousand cycles before suffering severe capacitance loss, the LSG/VOₓ SSC can retain 119% and 112% of its initial capacitance after continuously being charged and discharged at 40 A/g (12 mA cm⁻²) for 10,000 and 20,000 cycles, respectively, as illustrated in FIG. 11F. The supercapacitors produced with graphene materials comprising the vanadium oxides in multiple oxidation states increases in capacitance as the device cycles for the first few hundred cycles, resulting in an increase in a peak capacitance of ˜23% greater than an initial capacitance observed in the first ˜700 cycles, which was further investigated by measuring the respective voltages of the positive and negative electrodes with an Ag/AgCl reference electrode. As shown in the inset to FIG. 11F, the potentials of both electrodes gradually shifted in the negative direction. As a result, the 1.3 V voltage window moved from −0.5 V to 0.8 V (vs. Ag/AgCl) to −0.7 V to 0.6 V (vs. Ag/AgCl), stepping into the more electrochemically active region where one or two sets of redox peaks are seen in FIG. 7C and FIG. 9D, accounting for the unusual sharp capacitance increase in the first few hundred cycles. Even if the cycling stability is calculated based on the peak capacitance, the capacitance retention can still reach 92% after 19,000 cycles. Without being bound to a particular theory, as charge is cycled through the graphene scaffold comprising vanadium oxides, the capacity of the device to store charge may increase as additional charge transfer pathways are formed within the LSG framework where pseudocapacitive VOₓ nano-spacers are anchored, increasing the pseudocapacitive behavior of the VOₓ nanoparticles/nano-spacers and resulting in an increase in peak capacitance relative to an initial capacitance. In some embodiments, the supercapacitor device may increase in initial capacitance to a peak capacitance from about 1% to about 23% relative to an initial capacitance of the device. In some embodiments, the supercapacitor device may increase in initial capacitance to a peak of 1%, 2%, 3%, 4%, 5%, 6%, 7%, 8%, 9%, 10%, 11%, 12%, 13%, 14%, 15%, 16%, 17%, 18%, 19%, 20%, 21%, 22%, or 23% greater than the initial capacitance.

Therefore, the aqueous LSG/VOₓ SSCs can achieve a high energy density of 54 Wh/kg and a power density of 21 kW kg⁻¹ with a reliable operating voltage of 1.3 V, outperforming most aqueous vanadium-based SSCs that typically have potential windows of 0.8 V to 1 V.

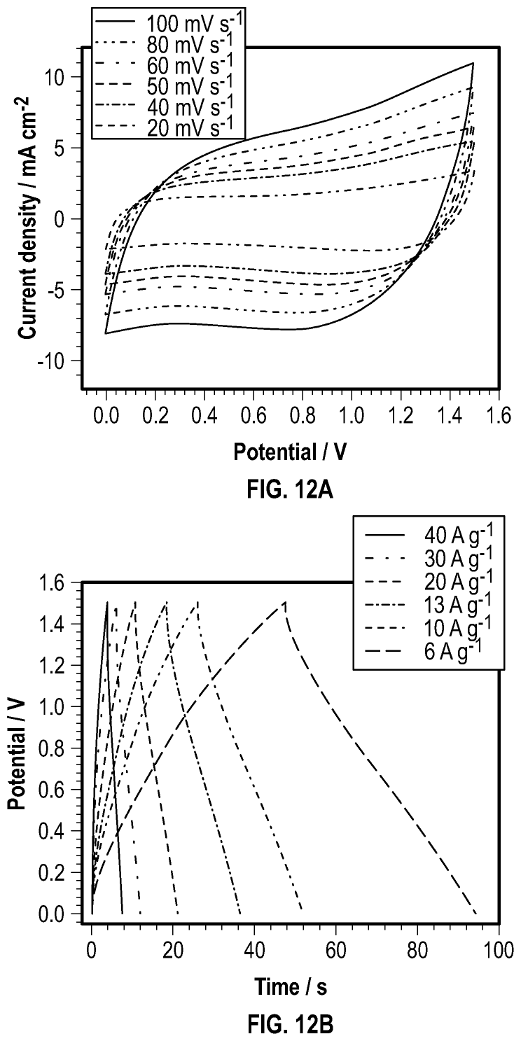

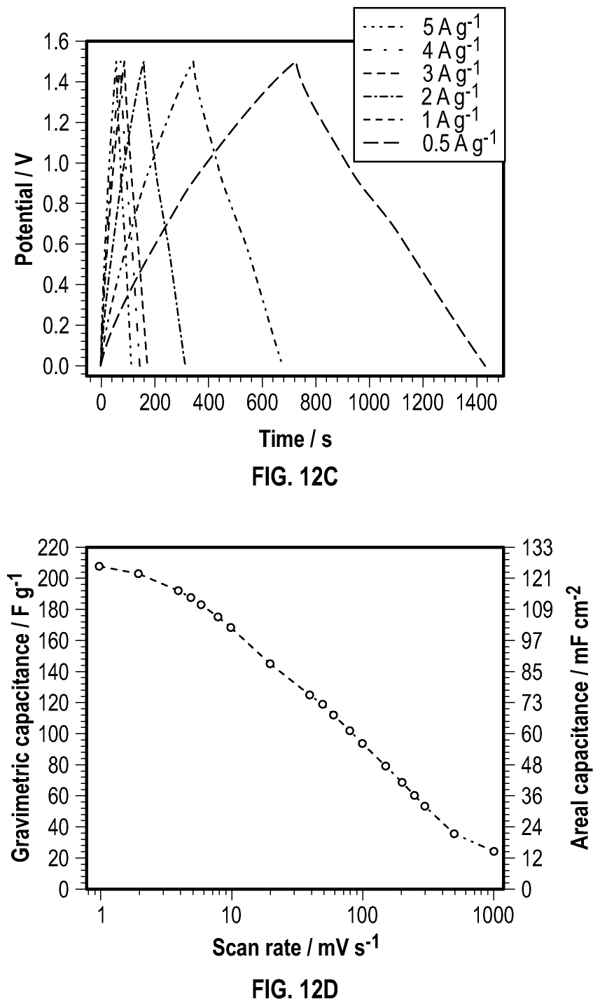

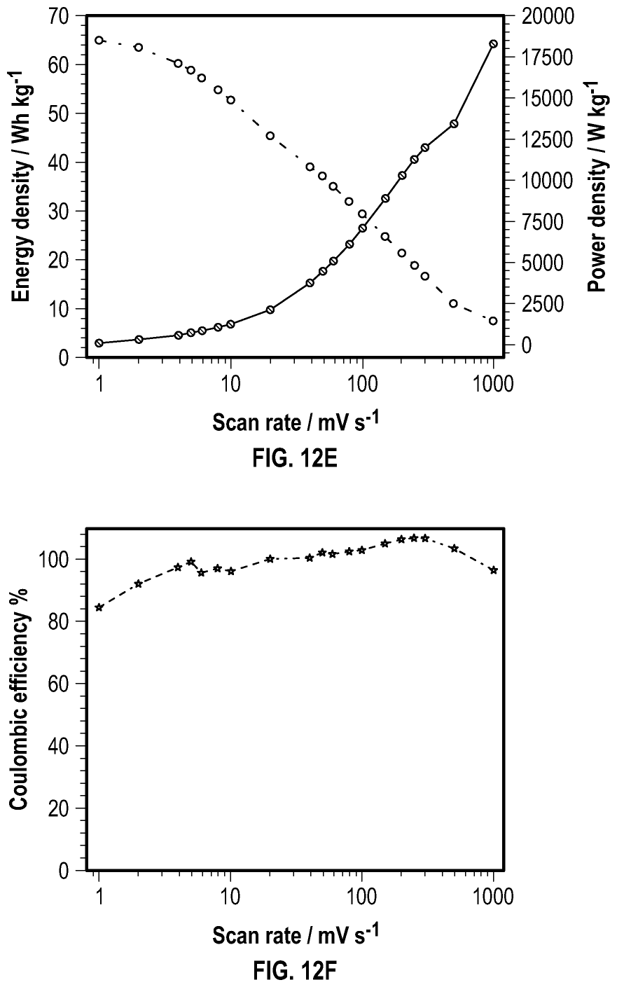

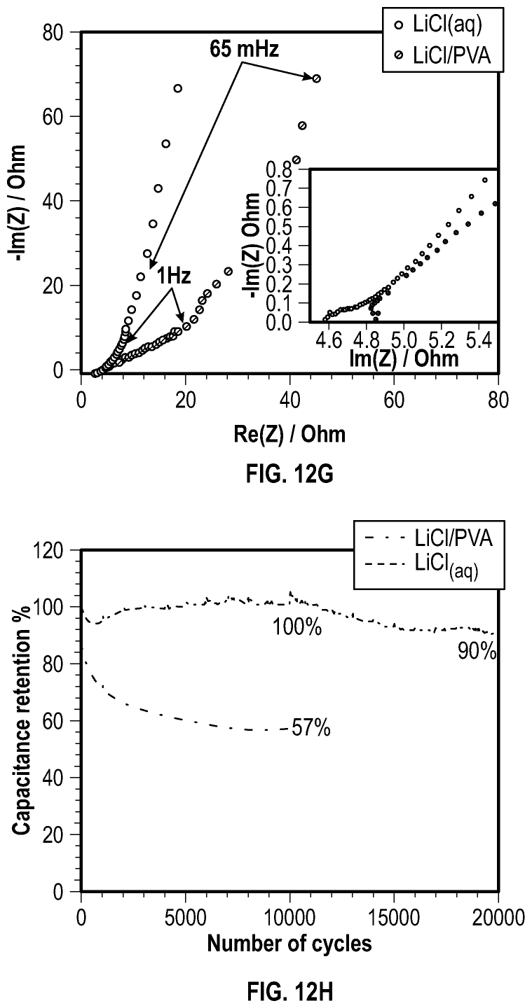

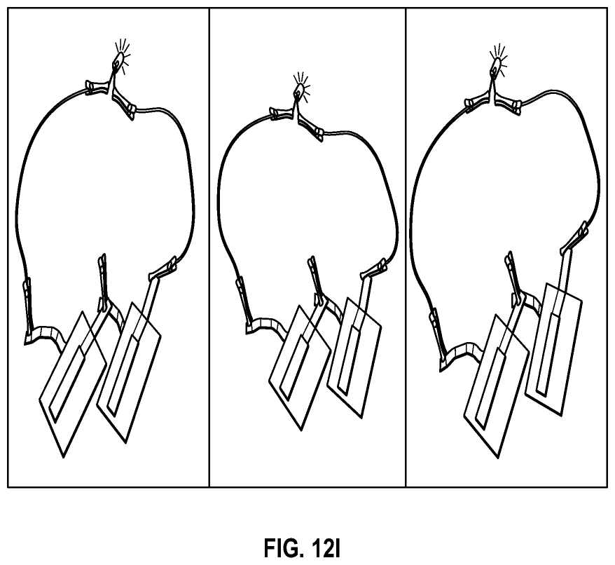

As it is desirable to increase the operating voltage of the LSG/VOₓ SSCs for more practical applications, quasi-solid-state LSG/VOₓ SSCs with a LiCl/PVA electrolyte were assembled and studied. Although vanadium possesses four (II-V) easily accessible oxidation states and its oxides are expected to have large stable electrochemically active voltage windows, the actual operating potential range is considerably constrained by the chemical dissolution and structural instability of the electrode material, which both lead to a dramatic loss of capacitance during constant charge/discharge cycling in aqueous electrolytes. The utilization of polymer gel electrolyte may be used to surmount this problem, in comparison with using flammable and toxic organic electrolytes or introducing a protective layer. The CV curves in FIG. 12A show a slightly distorted rectangular shape, confirming excellent supercapacitor behavior. Additionally, triangular GCD profiles also suggest that the capacitive mechanism of the gel LSG/VOₓ SSC may be attributed to fast surface Faradaic reactions (FIGS. 12B and 12C). Notably, the triangular shape holds even at an extremely low current density of 0.5 A/g, and the iR drop remains small even at a high current density of 40 A/g. As demonstrated in FIG. 12D, the gravimetric and areal capacitances increase as the current density falls, indicating a dominant pseudocapacitive contribution in the charge storage process. Based on CV calculations, the gravimetric device capacitance, energy density, and power density can reach 208 F/g, 65 Wh/kg, and 156 W kg⁻¹, respectively, at 1 mV s⁻¹ (FIG. 12E). As illustrated in FIG. 12F, the Coulombic efficiency of the quasi-solid-state LSG/VOₓ SSCs is close to 100% at all scan rates ranging from 1,000 mV s 1 to 5 mV s⁻¹ and can still retain 85% at 1 mV s⁻¹, indicating outstanding cycling stability.

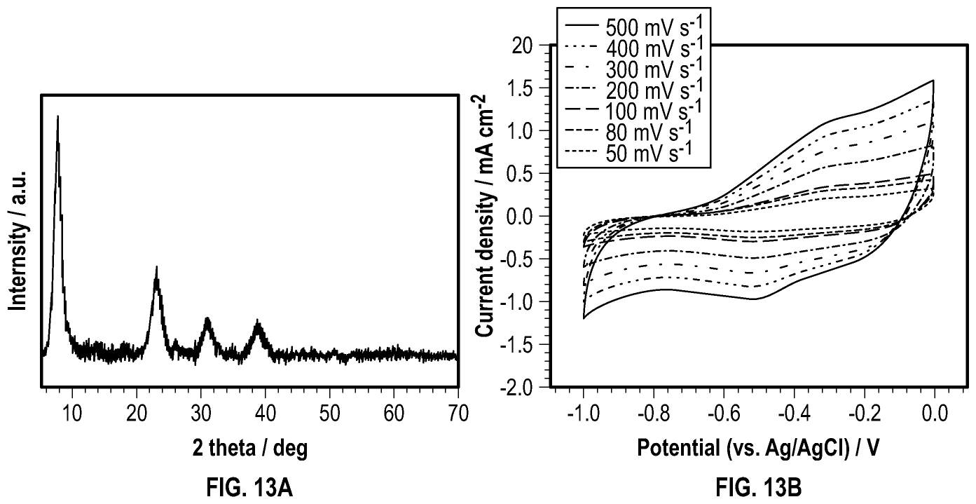

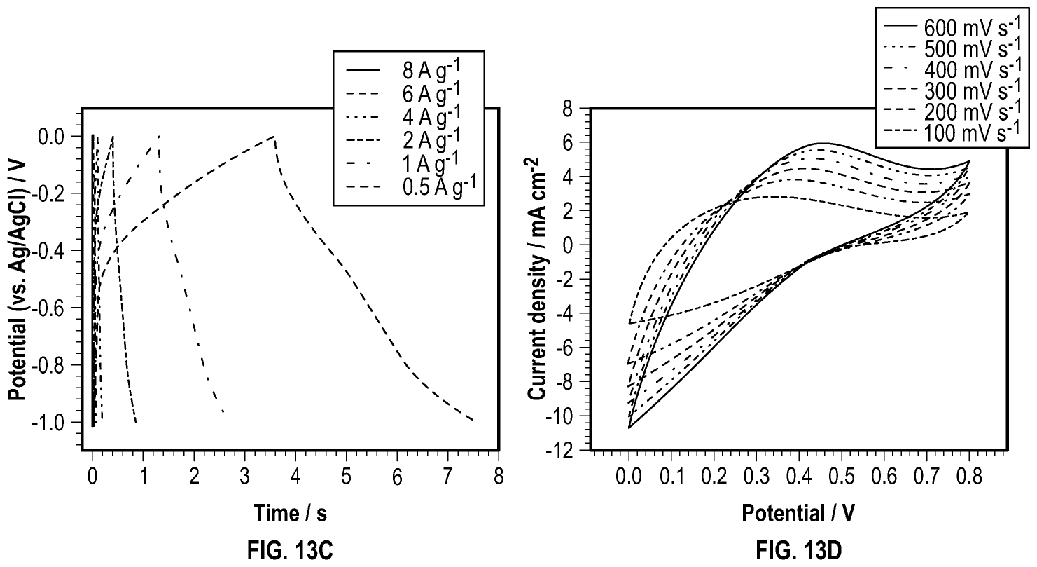

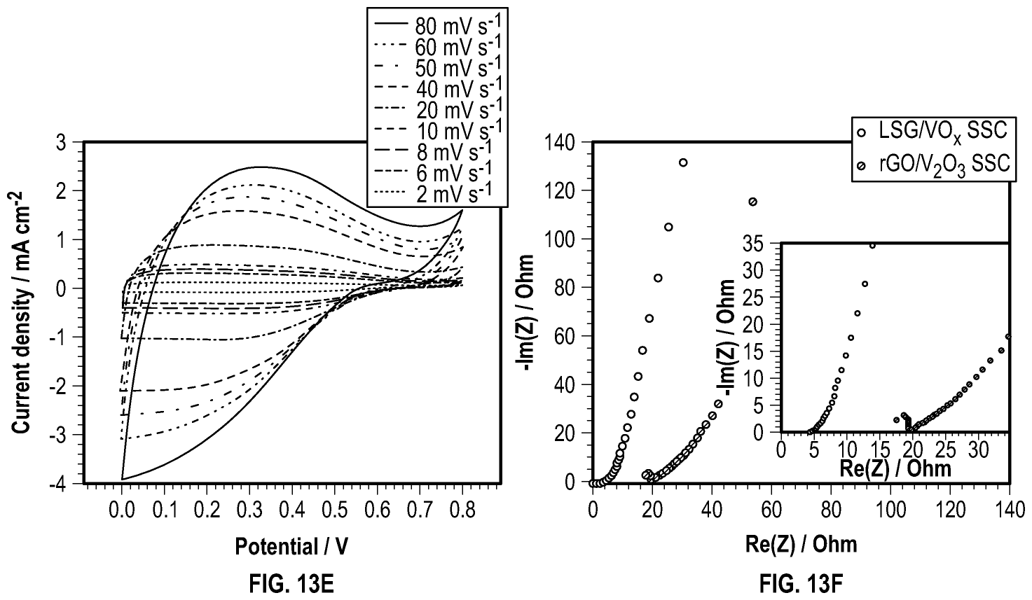

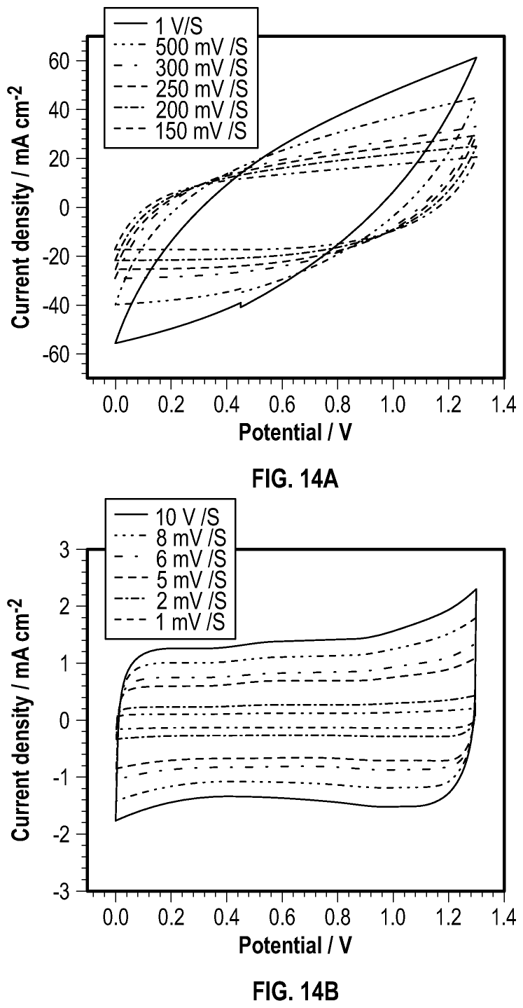

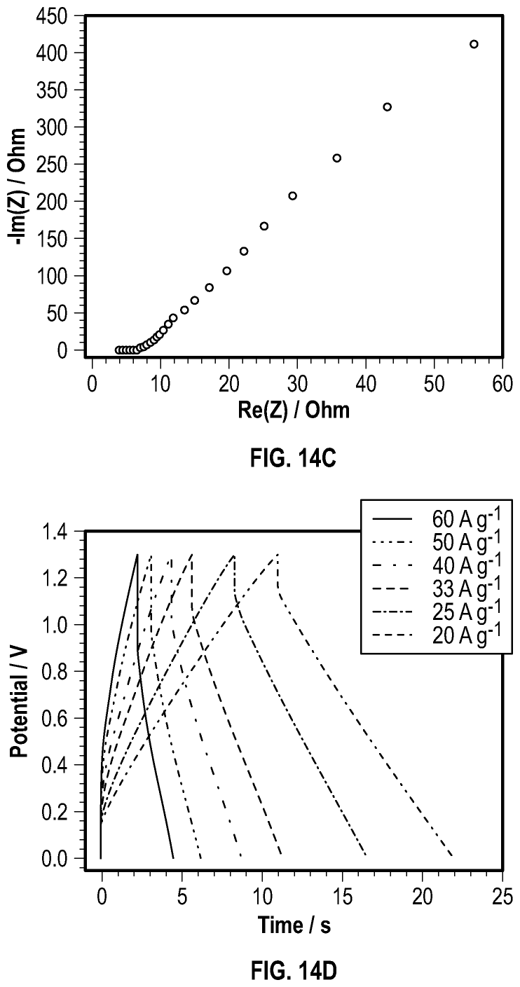

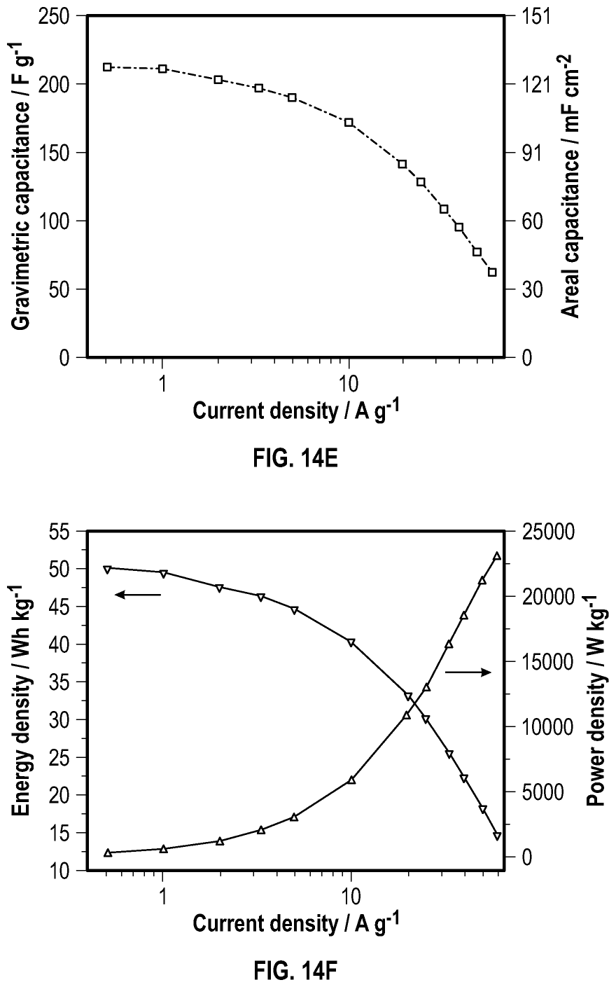

FIG. 12G compares the Nyquist plots of the aqueous and the gel LSG/VOₓ SSCs. As demonstrated in the inset, the equivalent series resistance of both devices is similar and below 5Ω, and the semicircle signifying R_{ct} may hardly be observed in either device, suggesting very small R_{ct} and very fast surface Faradaic reactions, as also verified by the small iR drops in the GCD measurements (FIGS. 13A to 13F and FIGS. 12B and 12C). Although both Nyquist plots show high slopes at low frequencies representing almost ideal capacitive performance, a Warburg region inclined at 45° is observed for the solid-state LSG/VOₓ SSC at higher frequencies, indicating that the charge transfer at the electrode-electrolyte interface is largely controlled by diffusion, which is expected for the lithium ion diffusion from the gel electrolyte to the electrode material. FIG. 12H evaluates the capacitance retention during continuous charging and discharging between 0 V and 1.5 V. The quasi-solid-state LSG/VOₓ SSC shows exceptional capacitance retention of ˜100% and 90% after being continuously charged and discharged at 30 A/g (9 mA cm⁻²) for 10,000 and 20,000 cycles, respectively, while the aqueous LSG/VOₓ SSC can only retain 57% of its initial capacitance after cycling 10,000 times. In summary, the quasi-solid-state LSG/VOₓ SSC with a cell voltage of 1.5 V can reach a high device capacitance, energy density, and power density and may show extraordinarily low capacitance loss that may be attributed to the limited chemical dissolution of the electrochemically active VOₓ species. By connecting two of the quasi-solid-state LSG/VOₓ SSCs in series, not only red LEDs, but also green (2.8 V, 20 mA) and blue (2.9 V, 20 mA) LEDs can be powered for over 10 minutes (FIG. 12I). The gel LSG/VOₓ SSCs are also flexible, as evidenced by the unchanged CV profile when the device is bent (FIGS. 14A to 14F).

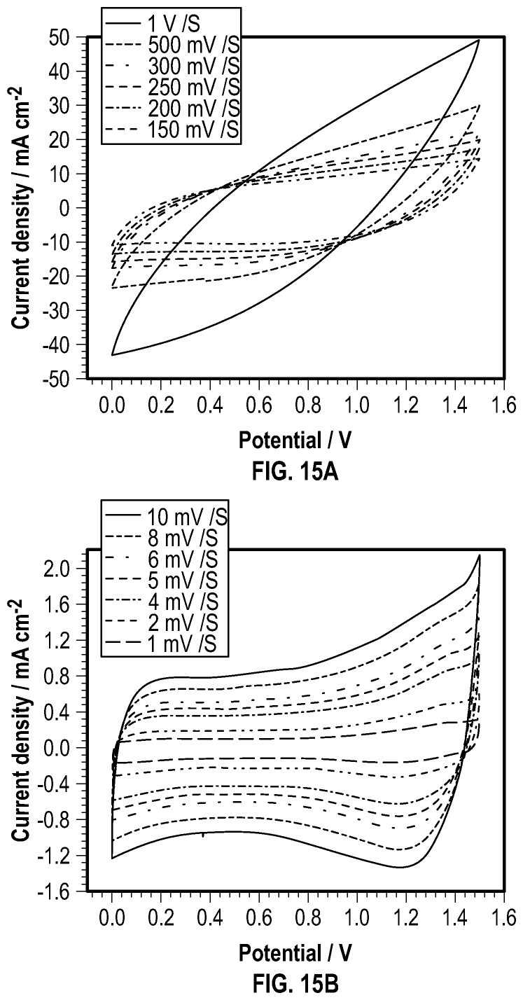

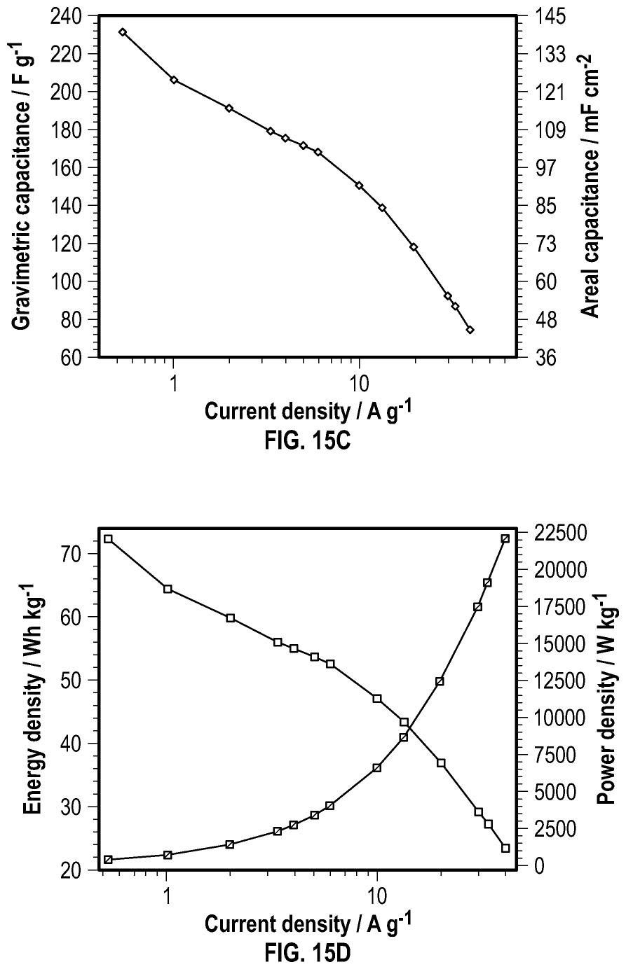

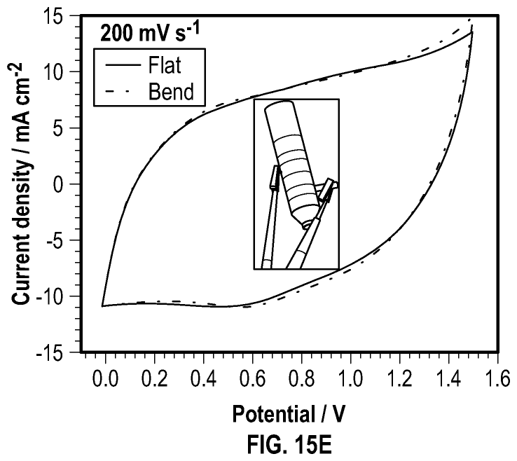

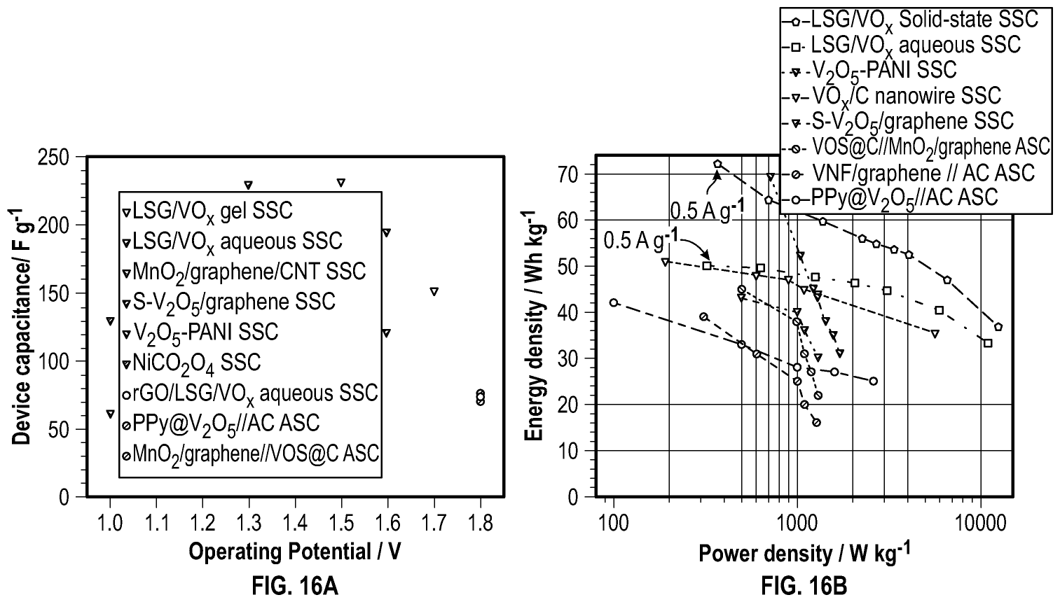

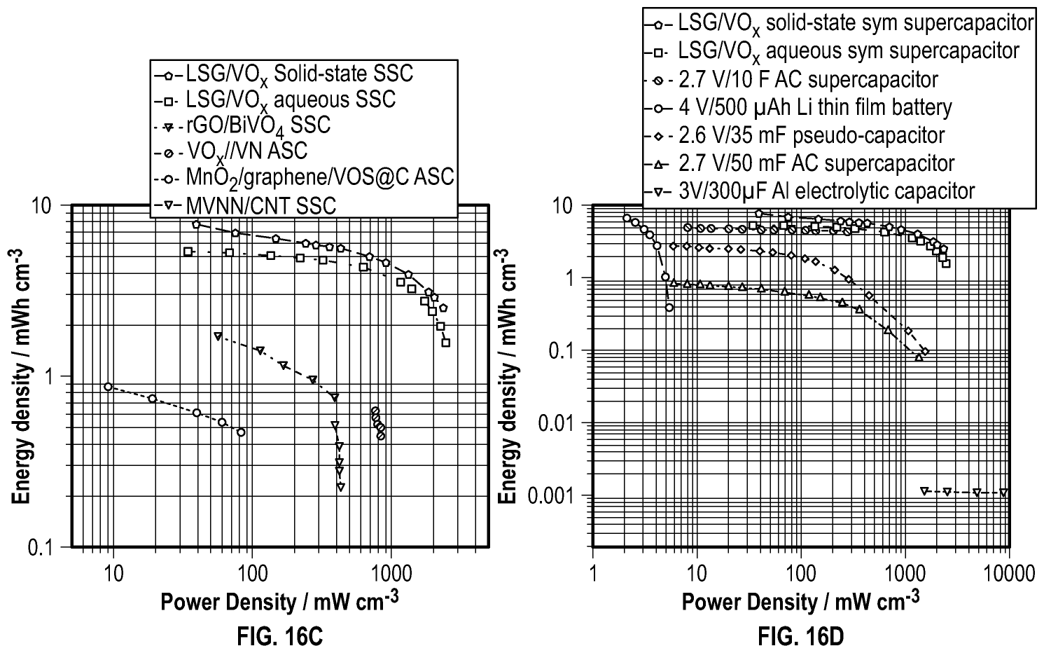

To explore the limit of the operating potential of devices based on the LSG/VOₓ electrodes, LiCl/PVA gel LSG/VOₓ SSCs with 1.7 V cell voltage and aqueous rGO//LSG/VOₓ asymmetric supercapacitors (ASCs) were assembled and tested. The 1.7 V quasi-solid-state LSG/VOₓ SSC can reach a high energy density of 60 Wh/kg and a power density of 127 W kg⁻¹ with satisfactory cycling stability of 75% capacitance retention after 10,000 cycles, although not outperforming the previously discussed 1.5 V device (FIGS. 15A to 15E). Without being bound to a particular theory, in some cases, the observable pair of redox peaks in the CV curves and the increased distortion of the GCD profiles may suggest the deteriorating energy storage performance may be explained by the involvement of the highly unstable VOₓ species that are seen in FIG. 15D. Similarly, while the cell voltage can be increased to 1.8 V by substituting rGO as the positive electrode, the behavior of the rGO//LSG/VOₓ ASC deviates from ideal supercapacitors, as not only indicated by the substantial distortion of the CV curves but also by signs of polarization observed at relatively high scan rates (FIGS. 15A to 15E). Additionally, since the rGO used was reduced chemically instead of undergoing laser scribing, the gravimetric electrochemical parameters of the rGO//LSG/VOₓ ASC are not as high as those of the LSG/VOₓ SSC, the thin-film electrodes of which have much higher specific capacitance (FIG. 7B). FIG. 16A is a plot of operating potential and gravimetric capacitance comparing the exemplary LSG/VOₓ devices with similar systems in the literature. In FIG. 16B, the operating voltage is plotted against the gravimetric device capacitance for SSCs (triangles) and ASCs (circles) of vanadium oxides or metal oxides. The performance of the aqueous LSG/VOₓ SSC (1.3 V, 229 F/g), the quasi-solid-state LSG/VOₓ SSC (1.5 V, 231 F/g; 1.7 V, 150 F/g), and the aqueous rGO//LSG/VOₓ ASC (1.8 V, 72 F/g) are all superior to the previously reported systems.

The energy storage performance of the aqueous and quasi-solid-state LSG/VOₓ SSCs according to the present disclosure are compared with previously reported vanadium oxides-based supercapacitors and with commercially available energy storage devices. FIG. 16B presents a Ragone plot of gravimetric energy and power density, in which the LSG/VOₓ SSC data were calculated based on the total active material mass. The aqueous and gel LSG/VOₓ SSCs can reach energy densities of 50 Wh/kg and 72 Wh/kg with power densities of 324 W kg⁻¹ and 370 W kg⁻¹ at 0.5 A/g, respectively, with the latter significantly outperforming other SSCs (triangles) and ASCs (circles) in the literature at similar power densities. Additionally, both LSG/VOₓ SSCs can achieve high power densities of greater than 1,000 W kg⁻¹ with the corresponding energy densities still above 30 Wh kg⁻¹, demonstrating superior rate capability. The volumetric energy and power densities of the aqueous and quasi-solid-state LSG/VOₓ SSCs were calculated based on the total volume of the electrodes, current collectors, separator, and electrolyte and are compared with vanadium oxide systems in the literature and commercially available energy storage devices in FIG. 16C. The aqueous and gel LSG/VOₓ SSCs can reach energy densities of 5.3 mWh/cm³ and 7.7 mWh/cm³ with power densities of 35 mWh/cm³ and 39 mWh/cm³ at 0.5 A/g, respectively. Both LSG/VOₓ SSCs can achieve better electrochemical performance than previously reported systems and current commercial devices. In particular, both devices can attain similar energy densities to a 500 mAh/g 4V lithium thin-film battery, with power densities almost 20 times higher. Additionally, the LSG/VOₓ SSCs can achieve high power densities (>1,000 mWh/cm³) that are comparable with that of a 3 V/300 μF Al electrolytic capacitor, while obtaining energy densities that are nearly four orders of magnitude higher. Thus, as indicated by the foregoing results, the LSG/VOₓ SSCs are promising candidates for future energy storage applications. FIG. 16D is a Ragone plot comparing the volumetric energy and power densities of exemplary LSG/VOₓ SSCs to commercial energy storage devices.

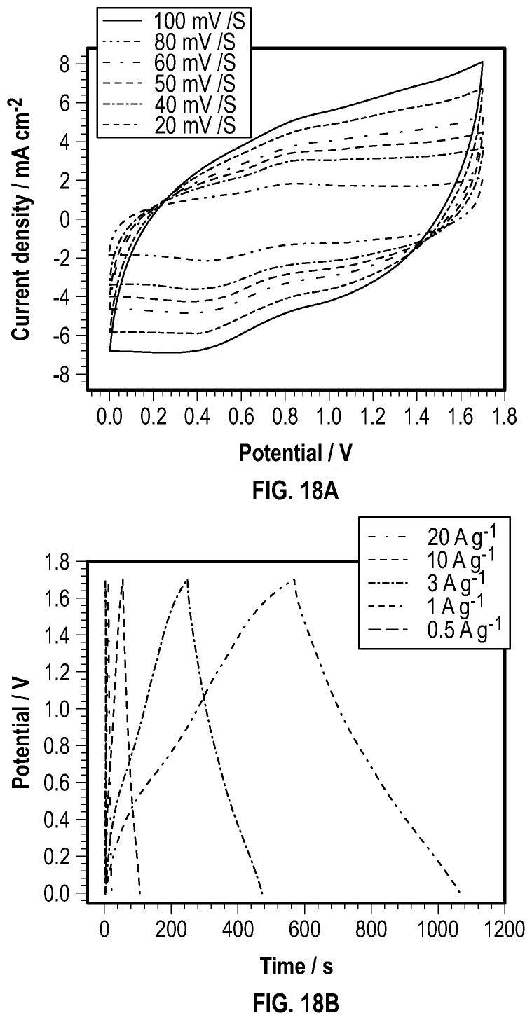

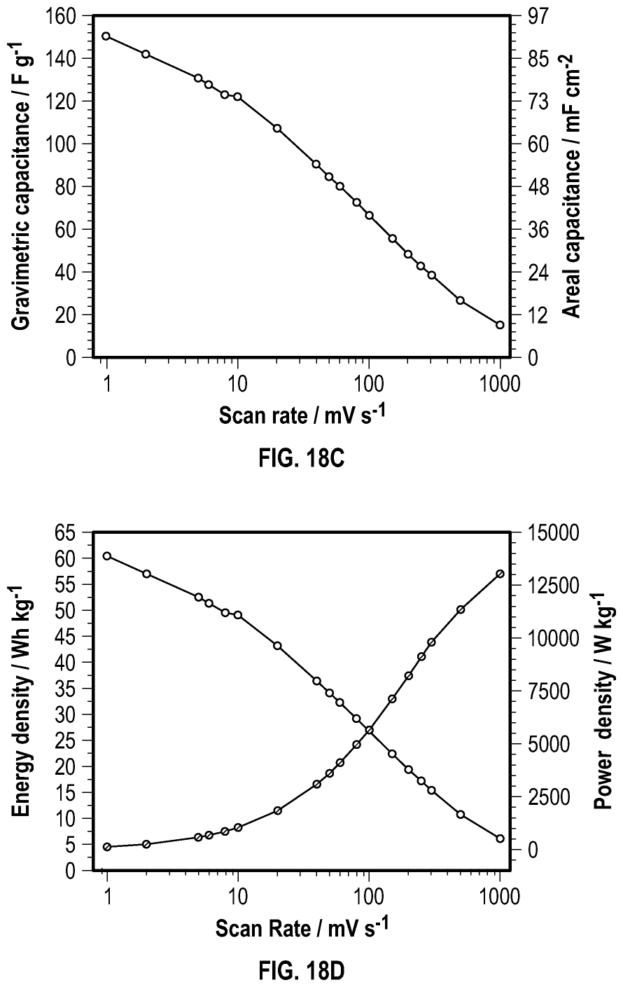

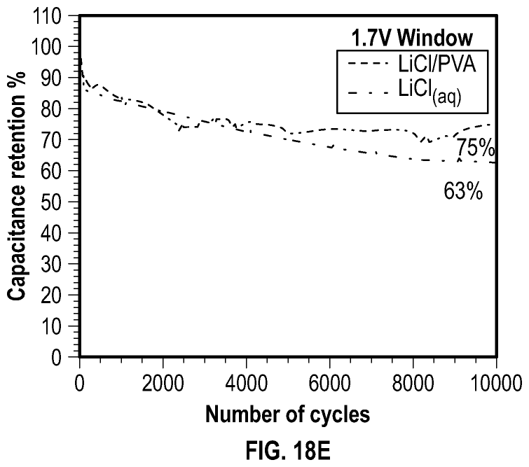

FIGS. 18A to 18E illustrate electrochemical measurements of a 1.7 V quasi-solid-state LSG/VOₓ SSC. FIG. 18A show CV curves of an aqueous LSG/VOₓ SSC at 20, 40, 50, 60, and 100 mV s⁻¹. FIG. 18B shows GCD curves of an aqueous LSG/VOₓ SSC at 0.5, 1, 3, 10, and 20 A/g. FIG. 18C shows gravimetric and areal capacitance of an aqueous LSG/VOₓ SSC at various scan rates. FIG. 18D shows gravimetric energy and power densities of an aqueous LSG/VOₓ SSC at various scan rates. FIG. 18E shows the long-term stability of an aqueous LSG/VOₓ SSC after 10,000 cycles, in comparison with the aqueous system.

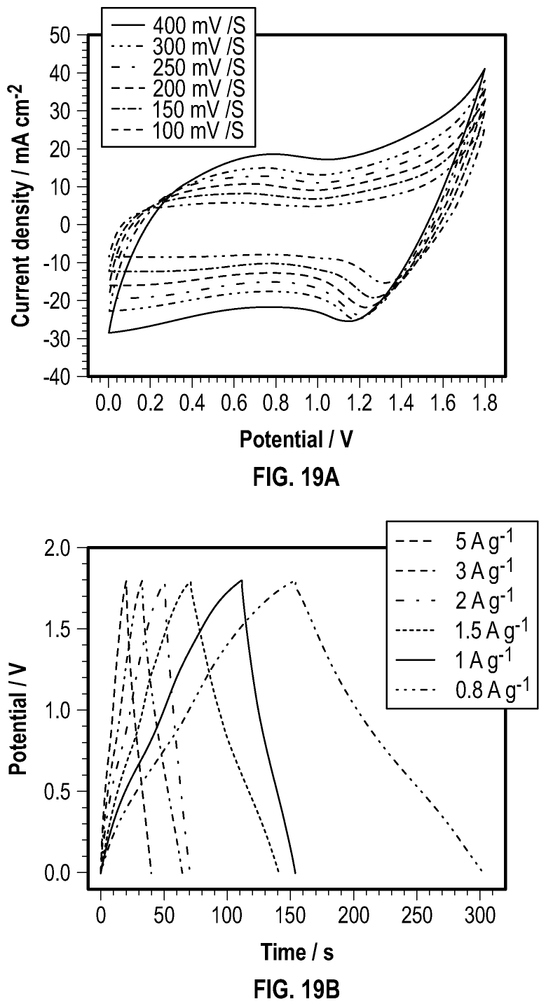

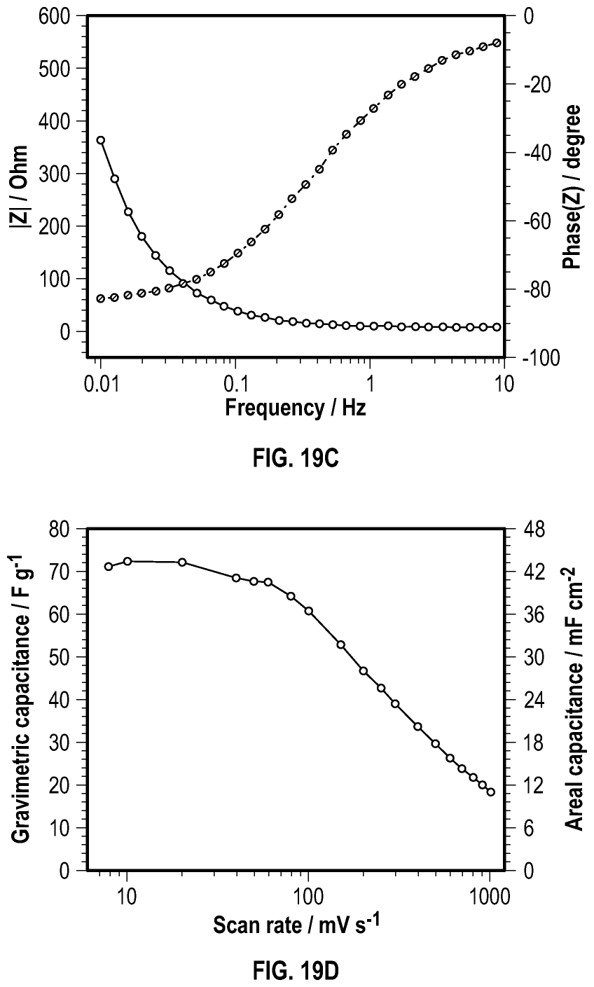

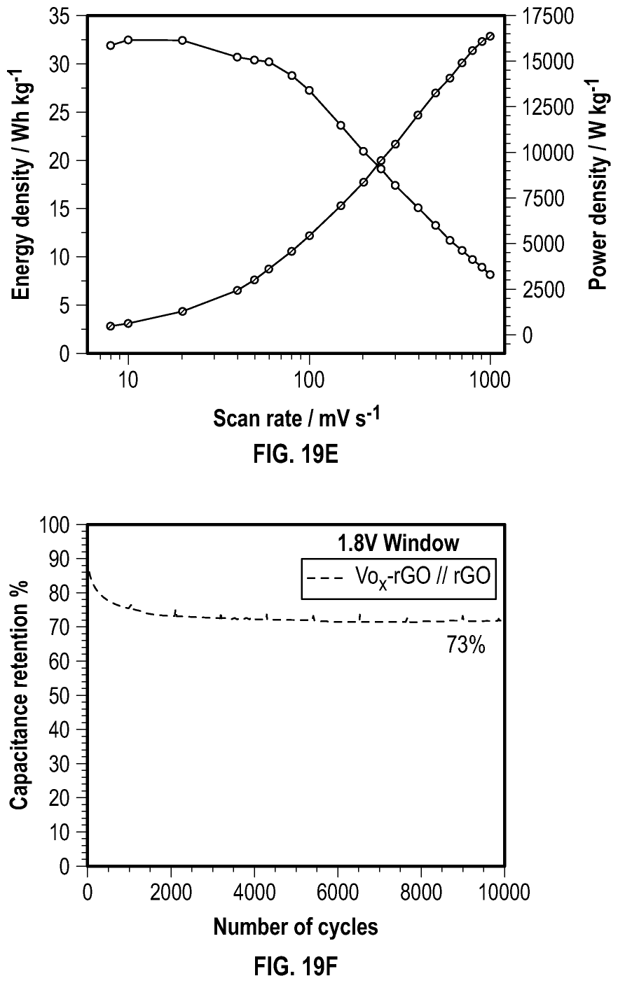

FIGS. 19A to 19E illustrate electrochemical measurements of an aqueous 10 M LiCl rGO//LSG/VOₓ asymmetric supercapacitor (ASC). FIG. 19A shows CV curves of an aqueous rGO//LSG/VOₓ ASC at 400, 300, 250, 200, 150, and 100 mV s⁻¹. FIG. 19B shows GCD curves of an aqueous rGO//LSG/VOₓ ASC at 0.8, 1, 1.5, 2, 3, and 5 A/g. FIG. 19C is a Bode plot of an aqueous rGO//LSG/VOₓ ASC. FIG. 19D shows gravimetric and areal capacitance of an aqueous LSG/VOₓ SSC at various scan rates. FIG. 19E shows gravimetric energy and power densities of an aqueous rGO//LSG/VOₓ ASC at various scan rates. FIG. 19F shows the long-term stability of an aqueous LSG/VOₓ SSC after 10,000 cycles.

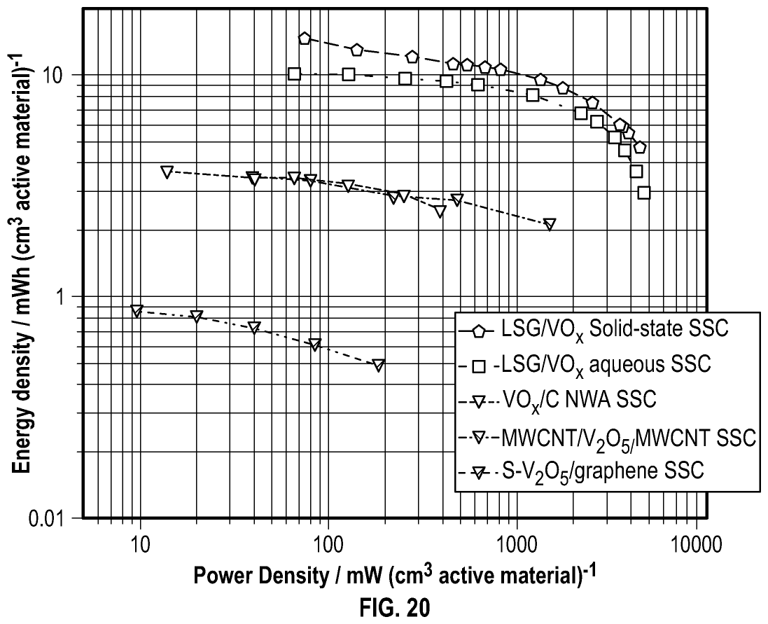

FIG. 20 is a Ragone plot comparing the volumetric energy and power densities of LSG/VOₓ SSCs with other vanadium oxide systems reported in the literature, normalized to active material volume.

In summary, graphene/vanadium oxide-based thin-film SSCs with high energy density and excellent cycling stability are disclosed. The LSG/VOₓ nanocomposite electrodes may be produced in a facile laser-scribing process in which reduction of GO and formation of VOₓ occur simultaneously, leading to a high three-electrode specific capacitance of 1,110 F/g. The presence of multiple easily accessible valence states in the VOₓ particles formed provides a large electrochemically active potential window, and the LSG scaffold may supply fast charge transfer pathways. As a result, the aqueous LSG/VOₓ SSC can reach a high energy density of 54 Wh/kg at a power density of 894 W kg⁻¹ with essentially no capacitance loss after 20,000 cycles. Moreover, the voltage window can be extended to 1.5 V by employing a LiCl/PVA gel electrolyte with 90% capacitance retention. The flexible quasi-solid-state LSG/VOₓ SSC can reach a high energy density of 72 Wh/kg at a power density of 370 W kg 1 with extremely small charge transfer resistance and Coulombic efficiency close to 100% even at slow scan rates. Furthermore, not only does the gravimetric electrochemical performance of the LSG/VOₓ SSCs outperform those of similar systems reported in the literature, but also the volumetric energy and power densities may achieve the standards of commercial energy storage devices. Overall, the embodiments according to the present disclosure offer a promising strategy for the simple fabrication of high-performance supercapacitors that may be utilized in flexible, solid-state, wearable electronics.

### Experimental Data

Material characterization: The SEM images of the LSG/VOₓ nanocomposite were collected using a JEOL JSM-67 Field Emission Scanning Electron Microscope. Transmission electron microscopy was performed on a Tecnai G TF20 TEM (FEI Inc.), and the particle distribution was obtained from the analysis of TEM images using the ImageJ software. X-ray powder diffraction was performed by a Panalytical X'Pert Pro X-ray powder diffractometer using Cu Kα radiation with a wavelength of 0.154 nm on a silicon zero-background plate. The XPS spectra were acquired using a Kratos Axis Ultra DLD spectrometer equipped with a monochromatic Al Kα X-ray source. The mass of the active material on the electrode was measured using a Mettler Toledo MX5 microbalance with 0.001 mg sensitivity. Two or three electrodes were sampled from every batch, and the mean areal loading was found to be 0.3 mg cm⁻² with a standard deviation of 3.6%. The thickness of the electrodes (15 μm) was determined by cross-sectional SEM, and the thicknesses of the separator (7 μm) and current collectors (10 μm) were measured by a Mitutoyo digital micrometer.

Synthesis of LSG VOₓ: The graphite oxide (GO) was synthesized via a modified Hummer's method. In a typical synthesis, 1.5 mL of 10 mg ml⁻¹ GO stock was diluted with the addition of 0.6 mL deionized (DI) water, and the required amount of VCl₃ was dissolved in 1.5 mL of DI water. The two separate solutions were sonicated for 2 hours. Next, the VCl₃ solution was slowly added to the GO suspension while stirring at a controlled rate via a syringe pump. A volume of 100 μL of the resulting mixture was then drop-cast onto graphite paper (Panasonic) making the electrode area 1 cm² and was left to dry under ambient conditions. Finally, the dried film was laser scribed using a 40 W Full Spectrum Laser Muse 2D Vision Desktop CO₂ Laser Cutter with a 12% power setting. The as-made LSG/VOₓ electrodes were used for electrochemical testing and characterization.

Fabrication of aqueous LSG VOₓ symmetric supercapacitors: The aqueous LSG/VOₓ SSCs were fabricated from a pair of electrodes with active areas of 1 cm² sandwiched by a cellulose separator (Celgard) that was wetted in 10 M LiCl electrolyte. The current collectors were extended using 3M copper tape and the device was assembled using Kapton tape.

Fabrication of quasi-solid-state LSG VOₓ symmetric supercapacitors: To make the LiCl/PVA electrolyte, 1 g of PVA powder was added to 10 mL of DI water. The mixture was heated to 90° C. under stirring. After the powder was completely dissolved, 4.2 g of LiCl was added to the mixture and constantly stirred until a clear viscous solution formed. It was then cooled to room temperature.

A drop of the LiCl/PVA electrolyte was added to each of the electrodes and the separator and was left for 30 minutes. After the excess electrolyte was removed, the separator was sandwiched between the two electrodes, and the assembled device was dried at 40° C. overnight. Subsequently, the current collectors were extended using 3M copper tape and the device was assembled using Kapton tape. The quasi-solid-state LSG/VOₓ SSC was then sealed using parafilm to prevent absorption of moisture.

Electrochemical testing: The electrochemical properties of the LSG/VOₓ electrodes were assessed by CV, GCD, and electrochemical impedance spectroscopy measurements using a Biologic VMP3 electrochemical workstation equipped with a 10-A current booster (VMP3b-10, USA Science Instrument). For potentiostatic electrochemical impedance spectroscopy measurements (sinus amplitude 10 mV), 10 data points per decade were collected from 1 MHz to 1 mHz at the open circuit voltage. In three-electrode experiments, graphite paper and an Ag/AgCl electrode (BASi) were used as the counter and reference electrodes, respectively; and the electrodes were immersed in 10 M LiCl electrolyte. The potentials of individual electrodes during cycle life measurements were obtained by a three-channel measurement of a three-electrode system, with one channel carrying out charge/discharge of the LSG/VOₓ electrodes and the other monitoring the potential of the anode and cathode against the Ag/AgCl reference electrode.

The vanadium oxides/graphene hybrid electrodes fabricated by a facile laser irradiation method have a high specific capacitance and a wide electrochemical window due to the presence of multiple vanadium oxidation states. The aqueous and gel SSCs based on the electrodes show high energy densities and power densities, excellent cycling stability, and outstanding Coulombic efficiencies.

### Calculations

The specific capacitance of an electrode measured via CV or via GCD in a three-electrode setup was calculated using the following equations:

$$\\ \begin{matrix}{C}_{specific} = \frac{\int idV}{v \times V \times x} & ( 1 )\end{matrix}$$

$$\\ \begin{matrix}{C}_{specific} = \frac{2 \times i \times \int Vdt}{x \times \vert {V}_{f}^{{}_{} 2} - {V}_{i}^{{}_{} 2} \vert} & ( 2 )\end{matrix}$$

where ∫idV is the integration of the discharge half of the CV curve, V is the potential, v is the scan rate, x is either the active material mass or the active electrode area, t is the discharge time, and Vᵢ and V_{f} are the initial and final potentials, respectively.

For two-electrode systems, the gravimetric or areal device capacitance is calculated by

$$\\ \begin{matrix}{C}_{device} = \frac{\int idV}{v \times V \times 2 m} or {C}_{device} = \frac{i \times \int Vdt}{m \times \vert {V}_{f}^{{}_{} 2} - {V}_{i}^{{}_{} 2} \vert} , & ( 3 )\end{matrix}$$

where m is the active material mass.

The volumetric device capacitance is calculated by

$$\\ \begin{matrix}{C}_{device} = \frac{\int idV}{v \times V \times y} or {C}_{device} = \frac{2 \times i \times \int Vdt}{y \times \vert {V}_{f}^{{}_{} 2} - {V}_{i}^{{}_{} 2} \vert} , & ( 4 )\end{matrix}$$

where y is the total volume of the two electrodes, two current collectors, electrolyte, and separator, or the geometric area of the active material,

The device energy density and power density are calculated using the following equations:

$$\\ \begin{matrix}E ( Wh {kg}^{- 1} ) = \frac{1}{2} \times {C}_{device} {V}^{{}_{} 2} \times \frac{1 h}{3600 s} \times \frac{1000}{1 kg} & ( 5 )\end{matrix}$$

$$\\ \begin{matrix}P ( W {kg}^{- 1} ) = \frac{E}{t} & ( 6 )\end{matrix}$$

Table 1 shows the thickness and areal mass loading of active material, current collector, and separator in LSG/VOₓ SSCs.

TABLE 1

| | Thickness | Volume | Areal mass | Weight |
|---|---|---|---|---|
| | (μm) | (%) | loading (mg/cm²) | (%) |
| LSG/VOₓ | 15 | 52.6 | 0.3 | 14.7 |
| Current collector | 10 | 35.1 | 1.4 | 66.0 |
| Separator | 7 | 12.3 | 0.80 | 19.4 |
| Device total | 57 | 47.4 | 4.1 | 100.0 |

### Thermal Gravimetric Analysis

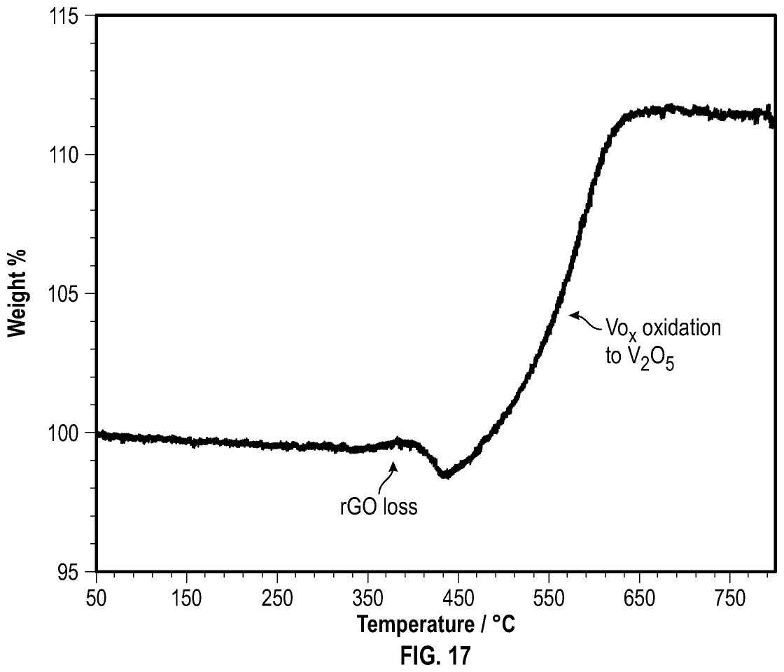

Thermal gravimetric analysis measurements were also performed to determine the weight % of VOₓ in the active material at a rate of 5° C. min⁻¹ in air, as shown in the FIG. 17. Between 350° C. and 650° C., the sample weight increased by about 12%, which accounts for the loss of GO and the oxidation of VOₓ to V₂O₅. Since both events occur in the same region, only an estimate may be obtained. According the XPS results, the four main oxidation states are +2, +3, +4, and +5, with at. % of 12.6, 69.9, 14.3, and 3.2, respectively, as summarized in Table 2.

TABLE 2

| VOₓ | Oxidation State | at. % | MW/g/mol |
|---|---|---|---|
| VO | +2 | 12.6 | 66.9 |
| VO_{1.5} | +3 | 69.9 | 74.9 |
| VO₂ | +4 | 14.3 | 82.9 |
| VO_{2.5} | +5 | 3.2 | 90.9 |

Assuming this ratio, the effective molecular weight of VOₓ is calculated to be 75.5 g mol⁻¹. Using the equation below,

$$\\ \frac{100 - {m}_{LSG} \%}{12 + {m}_{LSG} \%} = \frac{75.58}{90.94 - 75.59}$$

the weight % of LSG (m_{LSG} %) is determined to be 6.82% and that of VOₓ is determined to be 93.2%.

### Grid-Scale Energy Storage

Establishing grid-scale energy storage is one of the most important global challenges in the twenty-first century. Grid-scale energy storage will enable the transition to sustainable, yet intermittent, energy sources, for example, solar and wind. Although lithium-ion batteries dominate the portable electronics and electric vehicle markets, their advantages do not align well with the requirements of grid-scale energy storage. As an alternative, zinc (Zn) chemistry may potentially offer the cheap, long-lasting, and safe battery technology needed for grid storage, if some significant challenges may be overcome. Disclosed is a battery technology based on commercially proven materials synthesis methods and state-of-the-art characterization tools. Specifically, a high-capacity cathode material is engineered using laser-scribed synthesis, which reveals its fundamental working and failure modes using cryogenic electron microscopy (cryo-EM). In addition to developing a commercially relevant and critical battery technology, the present disclosure elucidates the molecular-scale operating principles of the cathode material.

As the fourth most mined metal on earth, Zn is an abundant, non-toxic, and promising material capable of enabling the terawatt-hour energy storage needed for the electrical grid. A critical challenge in developing rechargeable Zn battery chemistries is designing a low-cost cathode material that has long cycle life, high rate capabilities, and high capacity. Transition metal oxide cathodes have previously shown promising results but may exhibit some deficiencies.

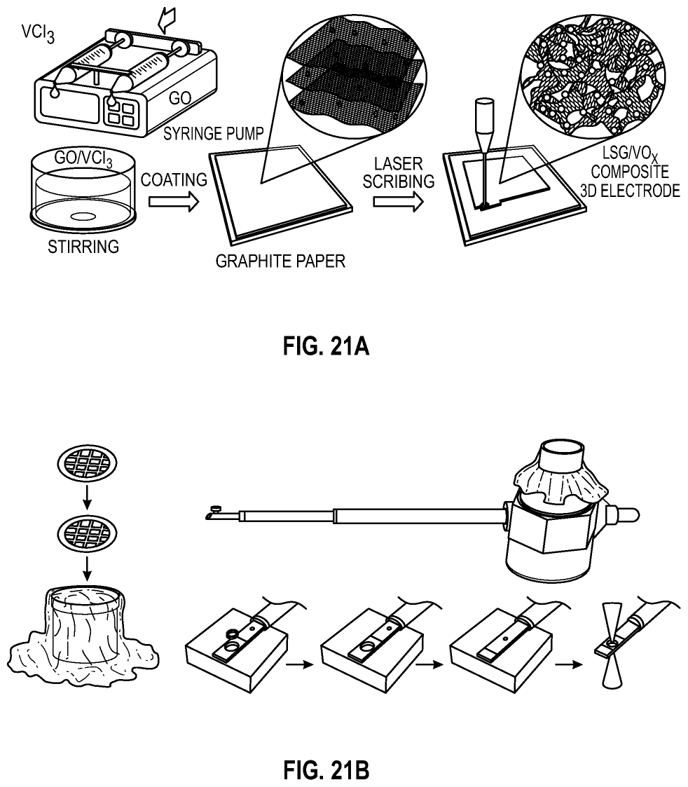

The present disclosure addresses leveraging of a laser-scribed method to engineer a graphene-vanadium oxide composite that may enhance both rate and cycling stability during battery operation (FIGS. 21A and 21B) and using state-of-the-art cryo-EM characterization to study reactive battery materials in their native environment with atomic detail so as to uncover how these materials operate and fail.

The power grid is a modern marvel, generating just the right amount of electricity to meet the demand instantaneously. However, only 2% of the 1,100 GW generated in the United States is stored, making the electrical grid incredibly vulnerable to fluctuations in power generation and demand. The recent power crisis in Texas highlights such vulnerabilities, where many power plants shut down due to the low winter temperatures, causing many residents to lose power in a time of critical need. Enabling grid-scale energy storage would improve the system's resiliency to natural disasters and provide a pathway for zero-emissions energy generation by solar and wind. Currently, grid-scale energy storage is dominated by pumped hydroelectricity, which is extremely efficient and long lasting, but geographically limiting. Therefore, developing disruptive storage technologies as an alternative to pumped hydroelectricity opens up opportunities for both scientific research and commercial growth.

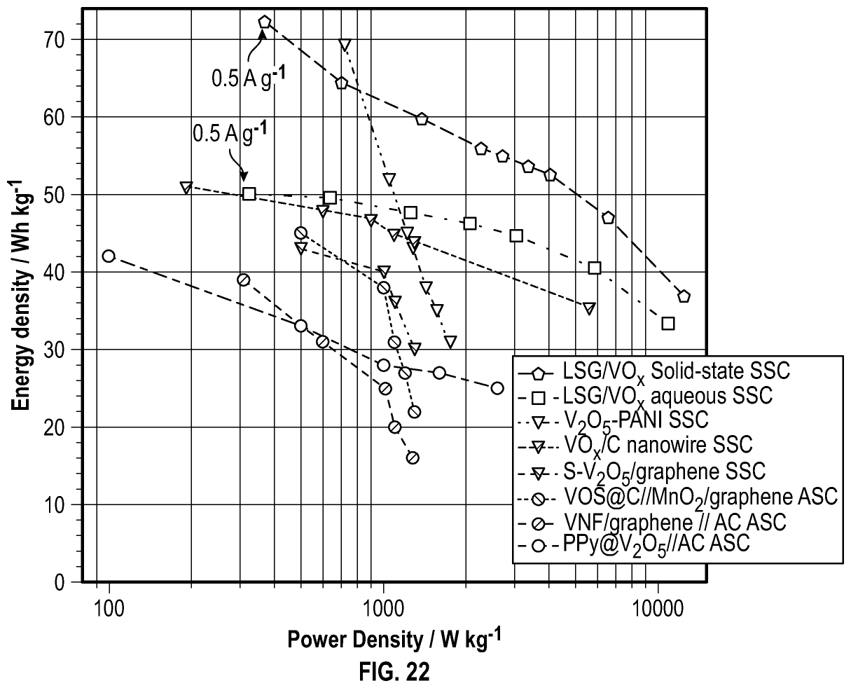

Preliminary data (FIG. 22) have demonstrated high-rate electrochemical performance of a carbon and vanadium oxide composite operating as a supercapacitor. However, supercapacitors do not have the sufficient energy density necessary for grid storage applications. The electrochemical properties of this composite may be leveraged based on transition metal oxides towards Zn battery chemistries using a unique and synergistic combination of materials engineering and advanced characterization as described subsequently.

Vanadium oxide (VOₓ) has the potential for accessing multiple valence states, making it a promising high-capacity cathode for Zn battery chemistries. Despite previous demonstrations of high rate operation enabled by complex synthetic routes to form conductive carbon composites, the multivalency of vanadium has not yet been leveraged to its full extent. The embodiments of the present disclosure open up multiple accessible oxidation states of vanadium through a facile laser-scribing process that incorporates VOₓ onto a conductive graphene scaffold in a one-step synthesis. The resulting interconnected pore network of the graphene scaffold enables fast electron and ion diffusion to the VOₓ surfaces, while the multivalent VOₓ generated by laser-scribing enable high-capacity storage.

To accomplish this, a film is cast from a precursor solution consisting of graphene oxide and VCl₃. The negatively charged graphene oxide surfaces and the V³⁺ ions in solution enable a well-mixed solution without any aggregation. Laser scribing using a CO₂ laser under ambient conditions then converts the dried film into a composite of VOₓ species and structurally expanded LSG. The film formed from this one-step process may then be used as a cathode without further processing. To evaluate the electrochemical performance of the as-synthesized LSG/VOₓ composite as a Zn battery cathode, batteries were constructed in a coin cell format using standard conditions, with Zn foil as the anode and 2.0 M ZnSO₄ as the electrolyte. The rate performance, cycling stability, and energy density of such coin cells was characterized using battery cyclers. Once improved electrochemical performance had been achieved, larger batteries in the pouch cell format were assembled to provide electrochemical data in an industrially relevant battery architecture. To optimize the one-step synthesis for improved electrochemical performance, the concentration of VCl₃ (and other V precursors) and its ratio with graphene oxide was varied in solution to identify the ideal loading for the composite electrodes in battery applications. The data analysis and expected outcomes of these conditions are described subsequently.

Limitations in understanding how battery materials operate and fail hinders the development of next-generation materials. In particular, there remains substantial disagreement in the literature on the origin of the storage capacity of VOₓ (for example, proton or Zn²⁺ intercalation, or pseudocapacitance) and failure mechanisms (for example, metal dissolution or the development of insulating by-products). To address this gap in understanding, characterization tools capable of preserving a battery in its native environment and providing high-resolution structural and chemical information are needed. The capabilities of cryo-EM adapted toward lithium battery chemistries may be leveraged to determine the spatial distribution of chemical and structural changes of the VOₓ cathode as the battery discharges and charges, providing important insights into the detailed mechanism of how the cathode operates and fails so as to guide engineering designs of the material.

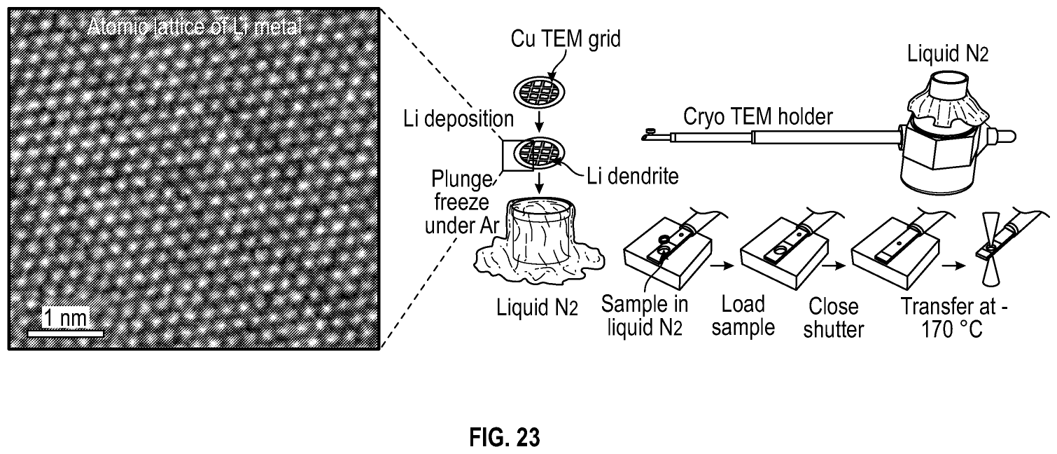

Cryo-EM methodologies to freeze and preserve the liquid-solid interfaces critical to electrochemical reactions may be developed. Using laser scribing, the graphene-vanadium oxide composite is directly synthesized onto a TEM grid substrate to be used as the cathode. After normal battery operation, the battery may be disassembled, and the TEM grid may be plunge-frozen into a cryogen to vitrify the liquid-solid interface. The electrochemical state of the battery at the time of freezing may be precisely controlled by monitoring the voltage profile. In this way, the battery material may be frozen and preserved at various points during its operation to observe how the local surface structure and chemistry evolves. High-resolution imaging may be used to observe the atomic surface of the LSG-VOₓ composite. Furthermore, energy dispersive spectroscopy in conjunction with scanning transmission electron microscopy enables elemental mapping of the chemical composition at the liquid-solid interface. Previous data (FIG. 23) show that cryo-EM may achieve atomic-resolution for both structural and chemical analysis of sensitive battery materials such as lithium metal. For the cryo-EM experiments, it is critical to closely monitor and control the electron dose rate, as the vitrified aqueous film is particularly susceptible to electron beam damage. This important capability may be enabled by low-dose detector-equipped electron microscopes, which routinely image biomolecules frozen in their aqueous environments.

### Data Analysis and Preliminary Expected Outcomes

Data analysis may confirm successful synthesis of the Zn battery cathode material according to the present disclosure and that it exhibits favorable electrochemical properties. This requires both materials and electrochemical characterization. The analysis on preliminary data (FIGS. 3A to 3F) shows the structure and chemistry of the initial composite material: electron micrographs indicate that the vanadium oxide particles are strongly adhered to the graphene substrate, while XRD and XPS show that the VOₓ is comprised of mixed-valence states (V⁺² to V⁺⁵), including V₂O₃, VO₂, and others. This validates the one-step laser scribing methodology and provides guidance for optimizing the process. The CV and galvanostatic cycling data may be obtained and analyzed from coin cell testing. The expected outcome for the storage capacity of LSG-VOₓ is higher than 400 mAh/g, since the multivalency of vanadium is predicted to give more charge capacity. Furthermore, this increased capacity is expected to be retained during repeated fast scan rates (e.g., 1 V s⁻¹) during cyclic voltammetry because of the high electrical conductivity and porous nature of the LSG framework. The ratio of vanadium precursor and graphene oxide is likely to impact electrochemical performance: increasing vanadium precursor enhances storage capacity of Zn ions, but too much may lead to aggregation and may inhibit the electrical conductivity of the graphene backbone. Both the materials characterization and electrochemical data analysis repeated for samples of varying vanadium loading may identify the optimum vanadium-graphene ratio to use during laser scribe synthesis.

Data analysis provides insight for the mechanism of Zn ion storage for the LSG-VOₓ composite. In particular, cryo-EM imaging and spectroscopic analysis of the cathode surface frozen at various states of charge may reveal both structural and chemical changes during battery cycling. The storage mechanism of VOₓ is highly dependent on its valency. For a multivalent composite, this results in a combination of proton and Zn²⁺ intercalation, which may be observed by measuring the VOₓ lattice distance with high-resolution cryo-EM images. During intercalation of ions between the metal oxide layers, one may observe a lattice expansion of the VOₓ in the charged state (intercalated). Furthermore, preliminary data demonstrate a facile method for preserving the liquid-solid interface in lithium metal chemistries, and this modified technique may be applied for Zn battery chemistry. Chemical mapping of the liquid-solid interface with energy dispersive spectroscopy reveals potential corrosion films or dissolution products that form and may inhibit charge transfer reactions at the surface. Revealing these failure modes will guide iterative designs to overcome the failures for improved performance. The rich structural and chemical data of the LSG-VOₓ composite obtained using cryo-EM provides a more complete nanoscale picture of how the electrochemical reaction proceeds throughout charging and discharging.

Those skilled in the art will recognize improvements and modifications to the present disclosure. All such improvements and modifications are considered within the scope of the concepts disclosed herein.

What is claimed is:

1. An electrode comprising a graphene scaffold, the graphene scaffold comprising a three-dimensional network of interconnected pores, a first vanadium oxide in a first oxidation state, and a second vanadium oxide in a second oxidation state.

2. The electrode of claim 1, wherein the graphene scaffold comprises an interconnected corrugated carbon-based network (ICCN) having a plurality of expanded and interconnected carbon layers.

3. The electrode of claim 1 or 2, wherein the graphene scaffold has a pore size from about 0.1 μm to about 10 μm.

4. The electrode of any one of claims 1 to 3, wherein the graphene scaffold has a pore size from about 0.5 μm to about 5 μm

5. The electrode of any one of claims 1 to 4, further comprising a third vanadium oxide in a third oxidation state.

6. The electrode of any one of claims 1 to 5, further comprising a fourth vanadium oxide in a fourth oxidation state.

7. The electrode of any one of claims 1 to 6, wherein the first vanadium oxide comprises Vanadium (III) Oxide (V₂O₃).

8. The electrode of claim 7, wherein the concentration of V₂O₃ in the electrode is from about 60%-80% w/w.

9. The electrode of claim 7 or 8, wherein the concentration of V₂O₃ in the electrode is about 70% w/w.

10. The electrode of any one of claims 7 to 9, wherein the V₂O₃ comprises a rhombohedral corundum-type structure.

11. The electrode of any one of claims 1 to 6, wherein the second vanadium oxide comprises Vanadium (IV) Oxide (VO₂).

12. The electrode of claim 11, wherein the concentration of VO₂ in the electrode is from about 5%-25% w/w.

13. The electrode of claim 11 or 12, wherein the concentration of VO₂ in the electrode is about 14.3% w/w.

14. The electrode of any one of claims 1 to 6, further comprising a third vanadium oxide.

15. The electrode of claim 14, wherein the third vanadium oxide comprises Vanadium (II) Oxide (VO).

16. The electrode of claim 14 or 15, wherein the concentration of VO in the electrode is from about 5%-25% w/w.

17. The electrode of any one of claims 14 to 16, wherein the concentration of VO in the electrode is about 12.6% w/w.

18. The electrode of any one of claims 1 to 6, further comprising a fourth vanadium oxide.

19. The electrode of claim 18, wherein the fourth vanadium oxide comprises Vanadium (V) Oxide (V₂O₅).

20. The electrode of claim 18 or 19, wherein the concentration of V₂O₅ in the electrode is from about 0.5%-15% w/w.

21. The electrode of any one of claims 18 to 20, wherein the concentration of V₂O₅ in the electrode is about 3.2% w/w.

22. The electrode of any one of claims 1 to 21, wherein the electrode exhibits sharp peaks at 24.4°, 33.2°, 36.4°, and 54.2° when analyzed by x-ray powder diffraction.

23. The electrode of any one of claims 1 to 21, wherein the electrode exhibits a peak at 514.9 eV when analyzed by x-ray photoelectron spectroscopy.

24. The electrode of any one of claims 1 to 21, wherein the electrode exhibits a peak at 512.9 eV when analyzed by x-ray photoelectron spectroscopy.

25. The electrode of any one of claims 1 to 21, wherein the electrode exhibits a peak at 517.9 eV when analyzed by x-ray photoelectron spectroscopy.

26. The electrode of any one of claims 1 to 25, further comprising non-stoichiometric vanadium oxides.

27. The electrode of any one of claims 1 to 26, wherein the total vanadium oxide content is about 93% w/w, and the graphene content is about 6.8% w/w.

28. The electrode of any one of claims 1 to 27, wherein any of the vanadium oxides comprises vanadium oxide nanoparticles.

29. The electrode of claim 28, wherein the vanadium oxide nanoparticles have a mean particle size ranging from about 10 nm to about 70 nm.

30. The electrode of claim 28 or 29, wherein the vanadium oxide nanoparticles have a mean particle size ranging from about 15 nm to about 50 nm.

31. The electrode of any one of claims 28 to 30, wherein the vanadium oxide nanoparticles have a mean particle size ranging from about 15 nm to about 30 nm.

32. The electrode of any one of claims 28 to 31, wherein the vanadium oxide nanoparticles have a mean particle size ranging from about 20 nm to about 30 nm.

33. The electrode of any one of claims 28 to 32, wherein the vanadium oxide nanoparticles have a mean particle size ranging from about 25 nm to about 30 nm.

34. The electrode of any one of claims 28 to 33, wherein the vanadium oxide nanoparticles have a mean particle size of about 25 nanometers.

35. The electrode of any one of claims 28 to 34, further comprising an interconnected network of vanadium oxide nanoparticles of differing particle size.

36. The electrode of any one of claims 1 to 35, wherein the graphene scaffold comprises an oxygen-containing functional group comprising C—O, C—O—C, C═O, or COOH.

37. The electrode of any one of claims 1 to 36, wherein the vanadium oxide nanoparticles are anchored to the graphene scaffold.

38. The electrode of any one of claims 1 to 37, wherein the vanadium oxide nanoparticles are anchored to the graphene scaffold at the oxygen-containing functional group.

39. The electrode of any one of claims 28-38, wherein the vanadium oxide nanoparticles are configured to improve the migration of an electrolyte ion into an active site of the electrode.

40. The electrode of any one of claims 1 to 39, wherein the electrode has a specific capacitance ranging from about 200 F/g at a scan rate of 1,000 mV/s to 1,050 at a scan rate of about 10 mV/s.

41. The electrode of any one of claims 1 to 40, wherein the electrode has a peak specific capacitance of about 1,110 F/g at a scan rate of about 20 mV/s.

42. The electrode of any one of claims 1 to 41, wherein the electrode has a resistance from about 0.2 ohms to about 0.4 ohms.

43. The electrode of any one of claims 1 to 42, wherein the electrode has a resistance of about 0.28 ohms.

44. The electrode of any one of claims 1 to 43, wherein the mean areal loading of the vanadium oxides is from about 0.05 mg/cm² to about 0.75 mg/cm².

45. The electrode of any one of claims 1 to 44, wherein the mean areal loading of the vanadium oxides is about 0.3 mg/cm².

46. The electrode of any one of claims 1 to 45, wherein the electrode has a thickness of about 5 μm to about 25 μm.

47. The electrode of any one of claims 1 to 46, wherein the electrode is about 15 μm thick.

48. The electrode of any one of claims 1 to 47, wherein the electrode is a nanocomposite electrode.

49. An energy storage device comprising: an electrode comprising a graphene scaffold, the graphene scaffold comprising a three-dimensional network of interconnected pores, a first vanadium oxide in a first oxidation state, and a second vanadium oxide in a second oxidation state; and an electrolyte.

50. The energy storage device of claim 49, further comprising a separator.

51. The energy storage device of claim 49 or 50, wherein the graphene scaffold comprises an interconnected corrugated carbon-based network (ICCN) having a plurality of expanded and interconnected carbon layers.

52. The energy storage device of any one of claims 49 to 51, wherein the energy storage device is a symmetric supercapacitor.

53. The energy storage device of any one of claims 49 to 52, wherein the energy storage device is a symmetric supercapacitor (SSC) comprising two electrodes of identical composition.

54. The energy storage device of claim 53, wherein the SSC has an operating voltage of about 1.3 V.

55. The energy storage device of claim 53 or 54, wherein the SSC retains over 100% of its initial capacitance after 10,000 cycles, or 20,000 cycles.

56. The energy storage device of any one of claims 53 to 55, wherein the SSC exhibits a triangular galvanostatic charge-discharge curve; or a galvanostatic charge-discharge curve comprising a first linear portion, a peak, and a second linear portion.

57. The energy storage device of claim 56 wherein the triangular galvanostatic charge-discharge curve maintains its shape at current densities of 0.5, 1, 2, 3, 4, and 5 A/g.

58. The energy storage device of any one of claims 53 to 57, wherein the SSC exhibits a resistance below about 5 ohms.

59. The energy storage device of any one of claims 53 to 58, wherein the SSC comprise a cell voltage of at least about 1.3 V.

60. The energy storage device of any one of claims 53 to 59, wherein the SSC has a cell voltage of about 1.3 V, 1.5 V, or 1.7 V.

61. The energy storage device of any one of claims 49 to 60, wherein the graphene scaffold has a pore size from about 0.1 μm to about 10 μm.

62. The energy storage device of any one of claims 49 to 61, wherein the graphene scaffold has a pore size from about 0.5 μm to about 5 μm.

63. The energy storage device of any one of claims 49 to 62, further comprising a third vanadium oxide in a third oxidation state.

64. The energy storage device of any one of claims 49 to 63, further comprising a fourth vanadium oxide in a fourth oxidation state.

65. The energy storage device of any one of claims 49 to 64, wherein the first vanadium oxide comprises Vanadium (III) Oxide (V₂O₃).

66. The energy storage device of any one of claims 49 to 65, wherein the concentration of V₂O₃ in the electrode is from about 60%-80% w/w.

67. The energy storage device of any one of claims 49 to 66, wherein the concentration of V₂O₃ in the electrode is about 70% w/w.

68. The energy storage device of any one of claims 49 to 67, wherein the V₂O₃ comprises a rhombohedral corundum-type structure.

69. The energy storage device of any one of claims 49 to 62, wherein the second vanadium oxide comprises Vanadium (IV) Oxide (VO₂).

70. The energy storage device of claim 69, wherein the concentration of VO₂ in the electrode is from about 5%-25% w/w.

71. The energy storage device of claim 69, wherein the concentration of VO₂ in the electrode is about 14.3% w/w.

72. The energy storage device of any one of claims 49 to 62, further comprising a third vanadium oxide.

73. The energy storage device of claim 72, wherein the third vanadium oxide comprises Vanadium (II) Oxide (VO).

74. The energy storage device of claim 72 or 73, wherein the concentration of VO in the electrode is from about 5%-25% w/w.

75. The energy storage device of any one of claims 72 to 74, wherein the concentration of VO in the electrode is about 12.6% w/w.

76. The energy storage device of any one of claims 49 to 62, further comprising a fourth vanadium oxide.

77. The energy storage device of claim 76, wherein the fourth vanadium oxide comprises Vanadium (V) Oxide (V₂O₅).

78. The energy storage device of claim 76 or 77, wherein the concentration of V₂O₅ in the electrode is from about 0.5%-15% w/w.

79. The energy storage device of any one of claims 76 to 78, wherein the concentration of V₂O₅ in the electrode is about 3.2% w/w.

80. The energy storage device of any one of claims 49 to 79, wherein the electrode exhibits sharp peaks at 24.4°, 33.2°, 36.4°, and 54.2° when analyzed by x-ray powder diffraction.

81. The energy storage device of any one of claims 49 to 80, wherein the electrode exhibits a peak at 514.9 eV when analyzed by x-ray photoelectron spectroscopy.

82. The energy storage device of any one of claims 49 to 80, wherein the electrode exhibits a peak at 512.9 eV when analyzed by x-ray photoelectron spectroscopy.

83. The energy storage device of any one of claims 49 to 80, wherein the electrode exhibits a peak at 517.9 eV when analyzed by x-ray photoelectron spectroscopy.

84. The energy storage device of any one of claims 49 to 83, further comprising non-stoichiometric vanadium oxides.

85. The energy storage device of any one of claims 49 to 84, wherein the total vanadium oxide content is about 93% w/w, and the graphene content is about 6.8% w/w.

86. The energy storage device of any one of claims 49 to 85, wherein any of the vanadium oxides comprises vanadium oxide nanoparticles.

87. The energy storage device of claim 86, wherein the vanadium oxide nanoparticles have a mean particle size ranging from about 10 nm to about 70 nm.

88. The energy storage device of any one of claim 86 or 87, wherein the vanadium oxide nanoparticles have a mean particle size ranging from about 15 nm to about 50 nm.

89. The energy storage device of any one of claims 86 to 88, wherein the vanadium oxide nanoparticles have a mean particle size ranging from about 15 nm to about 30 nm.

90. The energy storage device of any one of claims 86 to 89, wherein the vanadium oxide nanoparticles have a mean particle size ranging from about 20 nm to about 30 nm.

91. The energy storage device of any one of claims 86 to 90, wherein the vanadium oxide nanoparticles have a mean particle size ranging from about 25 nm to about 30 nm.

92. The energy storage device of any one of claims 86 to 91, wherein the vanadium oxide nanoparticles have a mean particle size of about 25 nanometers.

93. The energy storage device of any one of claims 86 to 92, further comprising an interconnected network of vanadium oxide nanoparticles of differing particle size.

94. The energy storage device of any one of claims 49 to 93, wherein the graphene scaffold comprises an oxygen-containing functional group comprising C—O, C—O—C, C═O, or COOH.

95. The energy storage device of any one of claims 49 to 94, wherein the vanadium oxide nanoparticles are anchored to the graphene scaffold.

96. The energy storage device of any one of claims 49 to 95, wherein the vanadium oxide nanoparticles are anchored to the graphene scaffold at the oxygen-containing functional group.

97. The energy storage device of any one of claims 86-96, wherein the vanadium oxide nanoparticles on the electrode are configured to improve the migration of an electrolyte ion into an active site of the electrode.

98. The energy storage device of any one of claims 49 to 97, wherein the electrolyte is an aqueous electrolyte, and the device is an aqueous SSC.

99. The energy storage device of claim 98, wherein the aqueous SSC retains about 119% of its initial capacitance after continuously being charged and discharged at 40 A/g (12 mA cm⁻²) for 10,000.

100. The energy storage device of claim 98 or 99, wherein the aqueous SSC retains about 112% of its initial capacitance after continuously being charged and discharged at 40 A/g (12 mA cm⁻²) for 20,000 cycles.

101. The energy storage device of any one of claims 98 to 100, wherein the aqueous SSC increases its initial capacitance by at least 20% after about 700 cycles.

102. The energy storage device of any one of claims 98 to 101, wherein the aqueous SSC maintains about 92% of its peak capacitance after 19,000 cycles.

103. The energy storage device of any one of claims 98 to 102, wherein the aqueous SSC maintains at least 85% of its peak capacitance after 19,000 cycles.

104. The energy storage device of any one of claims 98 to 103, wherein the aqueous SSC has an energy density of about 54 Wh/kg.

105. The energy storage device of any one of claims 98 to 104, wherein the aqueous SSC has an energy density of at least 45 Wh/kg.

106. The energy storage device of any one of claims 98 to 105, wherein the aqueous SSC has a power density of about 21 kW/kg.

107. The energy storage device of any one of claims 98 to 106, wherein the aqueous SSC has a power density of at least 15 kW/kg.

108. The energy storage device of any one of claims 98 to 107, wherein the aqueous SSC has an operating voltage of about 1.3 V, and a gravimetric capacitance of about 229 F/g.

109. The energy storage device of any one of claims 49 to 97, wherein the electrolyte comprises a gel electrolyte, and the device is a semisolid state SSC.

110. The energy storage device of claim 109, wherein the gel electrolyte comprises LiCl/PVA.

111. The energy storage device of claim 109 or 110, wherein the semisolid state SSC exhibits a gravimetric device capacitance of about 208 F/g at a scan rate of 1 mV/s.

112. The energy storage device of any one of claims 109 to 111, wherein the semisolid state SSC exhibits an energy density of about 65 Wh/kg at a scan rate of 1 mV/s.

113. The energy storage device of any one of claims 109 to 112, wherein the semisolid state SSC exhibits a power density of about 156 W/kg at a scan rate of 1 mV/s.

114. The energy storage device of any one of claims 109 to 113, wherein the semisolid state SSC is configured to increase the speed of faradic surface reactions.

115. The energy storage device of any one of claims 109 to 114, wherein the semisolid state SSC exhibits between 80% and 100% columbic efficiency.

116. The energy storage device of any one of claims 109 to 115, wherein the semisolid state SSC exhibits about 85% columbic efficiency at 1 mV/s.

117. The energy storage device of any one of claims 109 to 116, wherein the semisolid state SSC exhibits at least 85% columbic efficiency at scan rates from 1 mV/s to 1,000 mV/s.

118. The energy storage device of any one of claims 109 to 117, wherein the semisolid state SSC exhibits at least 80% capacitance retention after 10,000 cycles, or 20,000 cycles.

119. The energy storage device of any one of claims 109 to 118, wherein the semisolid state SSC exhibits between 90% to 100% capacitance retention after 10,000 cycles, or 20,000 cycles.

120. The energy storage device of any one of claims 109 to 119, wherein the semisolid state SSC exhibits between 90% to 100% capacitance retention after 10,000 cycles, or 20,000 cycles being continuously charged and discharged at 30 A/g (9 mA cm⁻²).

121. The energy storage device of any one of claims 109 to 120, wherein the semisolid state SSC is a flexible semisolid state SSC.

122. The energy storage device of claim 121, wherein the flexible semisolid state SSC maintains its cyclic voltammetry curves when bent.

123. The energy storage device of claim 121 or 122, wherein the flexible semisolid state SSC maintains its columbic efficiency, energy density, power density, or capacitance when bent.

124. The energy storage device of any one of claims 121 to 123, wherein the flexible semisolid state SSC comprises a Coulombic efficiency ranging from about 85% to about 100%.

125. The energy storage device of any one of claims 121 to 124, wherein the flexible semisolid state SSC has an operating voltage of about 1.5 V, and a gravimetric capacitance of about 230 F/g.

126. The energy storage device of any one of claims 121 to 125, wherein the flexible semisolid state SSC has an operating voltage of about 1.7 V, and a gravimetric capacitance of about 150 F/g.

127. The energy storage device of any one of claims 121 to 124, wherein the flexible semisolid state SSC comprises a Coulombic efficiency ranging from about 85% to about 100%, wherein about 85% Coulombic efficiency is achieved at 1 mV/s, and wherein about 100% Coulombic efficiency is achieved at about 1000 mV/s to about 5 mV/s.

128. A method of producing an electrode comprising:
i. providing a first solution of graphene oxide dissolved in an aqueous solution;
ii. providing a second solution of VCl₃ dissolved in an aqueous solution;
iii. mixing the first and the second solutions to form a third solution;
iv. applying the third solution onto a substrate;
V. drying the substrate; and
vi. laser scribing the substrate to form the electrode.

129. The method of producing the electrode of claim 128, wherein the substrate is graphite paper, a polymer, a silicon wafer, a flexible substrate, or combinations thereof.

130. The method of producing the electrode of claim 128 or 129, further comprising sonicating the first solution or the second solution prior to mixing.

131. The method of producing the electrode of any one of claims 128 to 130, further comprising sonicating the first solution or the second solution prior to mixing for at least one hour.

132. The method of producing the electrode of any one of claims 128 to 131, further comprising sonicating the first solution or the second solution prior to mixing for about 2 hours.

133. The method of producing the electrode of any one of claims 128 to 132, wherein the mixing comprises slowly adding the second solution to the first solution.

134. The method of producing the electrode of any one of claims 128 to 133, wherein the mixing is controlled via a syringe pump.

135. The method of producing the electrode of any one of claims 128 to 134, wherein the laser scribing comprises laser scribing with a 40 W full-spectrum CO₂ laser cutter at about 12% power.

136. The method of producing the electrode of any one of claims 128 to 135, wherein the laser scribing the substrate reduces the graphene oxide, and oxidizes the VCl₃ to a plurality of vanadium oxides.

137. The method of producing the electrode of any one of claims 128 to 136, wherein the laser scribing the substrate reduces the graphene oxide, and oxidizes the VCl₃ to a plurality of vanadium oxides, simultaneously.

138. The method of producing the electrode of any one of claims 128 to 137, wherein the laser scribing produces a conductive graphene scaffold comprising vanadium oxides with multiple oxidation states in one step.

139. The method of producing the electrode of any one of claims 128 to 138, wherein the graphene scaffold comprises a pore size from about 0.1 μm to about 10 μm.

140. The method of producing the electrode of any one of claims 128 to 139, wherein the graphene scaffold comprises a pore size from about 0.5 μm to about 5 μm

141. The method of producing the electrode of any one of claims 128 to 140, further comprising a third vanadium oxide in a third oxidation state.

142. The method of producing the electrode of any one of claims 128 to 141, further comprising a fourth vanadium oxide in a fourth oxidation state.

143. The method of producing the electrode of any one of claims 128 to 142, wherein the first vanadium oxide comprises Vanadium (III) Oxide (V₂O₃).

144. The method of producing the electrode of claim 143, wherein the concentration of V₂O₃ in the electrode is from about 60%-80% w/w.

145. The method of producing the electrode of claim 143 or 144, wherein the concentration of V₂O₃ in the electrode is about 70% w/w.

146. The method of producing the electrode of any one of claims 143 to 145, wherein the V₂O₃ comprises a rhombohedral corundum-type structure.

147. The method of producing the electrode of any one of claims 128 to 142, wherein the second vanadium oxide comprises Vanadium (IV) Oxide (VO₂).

148. The method of producing the electrode of claim 147, wherein the concentration of VO₂ is the electrode is from about 5%-25% w/w.

149. The method of producing the electrode of claim 147 or 148, wherein the concentration of VO₂ is the electrode is about 14.3% w/w.

150. The method of producing the electrode of any one of claims 128 to 142, further comprising a third vanadium oxide.

151. The method of producing the electrode of claim 150, wherein the third vanadium oxide comprises Vanadium (II) Oxide (VO).

152. The method of producing the electrode of claim 150 or 151, wherein the concentration of VO in the electrode is from about 5%-25% w/w.

153. The method of producing the electrode of any one of claims 150 to 152, wherein the concentration of VO in the electrode is about 12.6% w/w.

154. The method of producing the electrode of any one of claims 128 to 141, further comprising a fourth vanadium oxide.

155. The method of producing the electrode of claim 154, wherein the fourth vanadium oxide comprises Vanadium (V) Oxide (V₂O₅).

156. The method of producing the electrode of claim 154 or 155, wherein the concentration of V₂O₅ is the electrode is from about 0.5%-15% w/w.

157. The method of producing the electrode of any one of claims 154 to 156, wherein the concentration of V₂O₅ is the electrode is about 3.2% w/w.

158. The method of producing the electrode of any one of claims 128 to 157, wherein the electrode comprises sharp peaks at 24.4°, 33.2°, 36.4°, and 54.2° when analyzed by x-ray powder diffraction.

159. The method of producing the electrode of any one of claims 128 to 158, wherein the electrode comprises a peak at 514.9 eV when analyzed by x-ray photoelectron spectroscopy.

160. The method of producing the electrode of any one of claims 128 to 158, wherein the electrode comprises a peak at 512.9 eV when analyzed by x-ray photoelectron spectroscopy.

161. The method of producing the electrode of any one of claims 128 to 158, wherein the electrode comprises a peak at 517.9 eV when analyzed by x-ray photoelectron spectroscopy.

162. The method of producing the electrode of any one of claims 128 to 161, further comprising non-stoichiometric vanadium oxides.

163. The method of producing the electrode of any one of claims 128 to 162, wherein the total vanadium oxide content is about 93.1% w/w, and the graphene content is about 6.8% w/w.

164. The method of producing the electrode of any one of claims 128 to 163, wherein any of the vanadium oxides comprises vanadium oxide nanoparticles.

165. The method of producing the electrode of claim 164, wherein the vanadium oxide nanoparticles have a mean particle size ranging from about 10 nm to about 70 nm.

166. The method of producing the electrode of claim 164 or 165, wherein the vanadium oxide nanoparticles have a mean particle size ranging from about 15 nm to about 50 nm.

167. The method of producing the electrode of any one of claims 164 to 166, wherein the vanadium oxide nanoparticles have a mean particle size ranging from about 15 nm to about 30 nm.

168. The method of producing the electrode of any one of claims 164 to 167, wherein the vanadium oxide nanoparticles have a mean particle size ranging from about 20 nm to about 30 nm.

169. The method of producing the electrode of any one of claims 164 to 168, wherein the vanadium oxide nanoparticles have a mean particle size ranging from about 25 nm to about 30 nm.

170. The method of producing the electrode of any one of claims 164 to 169, wherein the vanadium oxide nanoparticles have a mean particle size of about 25 nanometers.

171. The method of producing the electrode of any one of claims 164 to 170, further comprising an interconnected network of vanadium oxide nanoparticles of differing particle size.

172. The method of producing the electrode of any one of claims 128 to 171, wherein a graphene scaffold comprises an oxygen-containing functional group comprising C—O, C—O—C, C═O, or COOH.

173. The method of producing the electrode of any one of claims 128 to 172, wherein the vanadium oxide nanoparticles are anchored to the graphene scaffold.

174. The method of producing the electrode of any one of claims 128 to 173, wherein the vanadium oxide nanoparticles are anchored to the graphene scaffold at the oxygen-containing functional group.

175. The method of producing the electrode of any one of claims 164 to 174, wherein the vanadium oxide nanoparticles are configured to improve the migration of an electrolyte ion into an active site of the electrode.

176. A method of producing an energy storage device comprising:
i. providing an electrode material comprising a graphene scaffold, the graphene scaffold comprising a three-dimensional network of interconnected pores, a first vanadium oxide in a first oxidation state, and a second vanadium oxide in a second oxidation state;
ii. inserting an electrolyte into the energy storage device;
iii. contacting the electrode material with at least one current collector; and
iv. sealing the energy storage device.

177. The method of producing an energy storage device of claim 176, further comprising providing two layers of the electrode material, and inserting the electrolyte such that it is contact with each layer.

178. The method of producing the energy storage device of claim 176 or 177, wherein inserting an electrolyte into the device comprises contacting a separator with the electrolyte, and inserting the separator into the device.

179. The method of producing the energy storage device of any one of claims 176 to 178, wherein the electrolyte is LiCl.

180. The method of producing the energy storage device of any one of claims, 176 to 179 wherein the electrolyte is a gelled electrolyte.

181. The method of producing the energy storage device of any one of claims 176 to 180, wherein the electrolyte is a gelled electrolyte comprises LiCl/PVA.

182. The method of producing the energy storage device of claim 181, wherein the LiCl/PVA is formed by adding PVA powder to an aqueous solution, heating the solution to about 90 C, adding LiCl to the solution, stirring the solution, and cooling the solution to room temperature.

183. The method of producing the energy storage device of any one of claims 178 to 182, wherein inserting the electrolyte into the energy storage device comprises applying the LiCl/PVA to each electrode and a separator, and inserting the separator between the two layers of the electrode material.
